(19) United States
(12) Patent Application Publication
(10) Pub. No.: US 2004/0160634 A1
(43) Pub. Date: Aug. 19, 2004

(54) Print service system

(76) Inventor: Mikio Watanabe, Asaki-shi (JP)

Correspondence Address: BIRCH STEWART KOLASCH & BIRCH, PO BOX 747, FALLS CHURCH, VA, 22040-0747, US

(21) Appl. No.: 10/777,750

(22) Filed: Feb. 13, 2004

(30) Foreign Application Priority Data
Feb. 17, 2003 (JP) 2003-038087
Mar. 25, 2003 (JP) 2003-083110

(51) Int. Cl. G06F 15/00

(52) U.S. Cl. 358/1.15

(57) ABSTRACT

The image data of an image captured by a user using an imaging apparatus is transmitted to a home server apparatus by wireless communications. Upon receipt of the image data, the home server apparatus automatically transmits the image data to the print server apparatus, and the print server apparatus transmits electronic mail including an image data output suggestion message and a procedure of placing an order when the amount of image data of the user has exceeded a predetermined value.

### BACKGROUND OF THE INVENTION

1. Field of the Invention

The present invention relates to a print service system, and more specifically to a print service system which provides a print service online.

2. Description of the Related Art

There has conventionally been a known system for providing a print service online for a user of an imaging apparatus such as a digital camera, etc. For example, there is a well-known system in which an order of a print service is placed by a user who transfers image data to a server apparatus in a service provider through a personal computer (hereinafter referred to as a PC), a mobile phone, etc. (See Japanese Patent Application Publication No. 2002-149796.)

However, in the conventional technique disclosed by Japanese Patent Application Publication No. 2002-149796, etc., the user has to store and manage the user's own image data, select an image to be transferred to a server, and transfer the image using a mobile phone, a PC, etc. These operations are time-consuming and laborious for a passive user and a beginner, and there are a number of users unwilling to use a print service online.

As a result, some amount of image data remains unprinted and accumulated for users, and the print service providers possibly miss a chance to receive an order from a user.

### SUMMARY OF THE INVENTION

The present invention has been made in view of the above-mentioned situations, and an object of the invention is to provide a print service system capable of allowing a user to quickly and easily use an online service, and a service provider to increase the chance to receive orders from users.

To attain the above-mentioned object, the first aspect of the present invention is a print service system comprising: an imaging apparatus including an imaging device which outputs image data of a photo image obtained by capturing an object, a first recording device which records the image data, and a first communications device which transmits the image data recorded in the first recording device to a predetermined home server apparatus; the predetermined home server apparatus including a second communications device which receives image data from the imaging apparatus, a second recording device which records the image data received by the second communications device, and a third communications device which automatically transmits the image data recorded by the second recording device and predetermined user information to a predetermined print server apparatus; and the predetermined print server apparatus including a fourth communications device which receives image data and the predetermined user information from the home server apparatus, a third recording device which records the image data received by the fourth communications device for each user specified by the predetermined user information, a user data management device which manages image data of a user recorded by the third recording device, and a first output device which outputs the image data recorded by the third recording device to a medium when the user issues an order, wherein: the user data management device updates at least one of a total number of pieces of image data and a total amount of image data about a user specified by the predetermined user information each time the fourth communications device receives image data and the predetermined user information from the home server apparatus, and automatically transmits message information to equipment registered in advance for the user when the updated result exceeds a predetermined value, wherein the message information includes a proposal for the user to output image data to a medium.

That is, since the imaging apparatus transmits image data to a predetermined home server apparatus, and the home server apparatus receives and records image data and automatically transmits the image data to a predetermined print server apparatus, it is not necessary for a user to activate equipment to transmit image data, access a server apparatus on a network. And image data is not transmitted to an improper print server apparatus by an erroneous operation.

Additionally, since the home server apparatus records received image data, the recorded data can be transmitted to a print server apparatus at any timing, for example, when the load on the home server apparatus is low. Furthermore, even when a print server apparatus is in an inoperable state or cannot transmit image data due to trouble occurring in the communications, the image data can be re-transmitted. Since image data can be automatically transmitted, the user is not required to operate a home server apparatus.

Thus, the user can quickly and easily transmit image data.

A print server apparatus updates the total number of pieces of image data of each user and the total amount of image data of each user each time image data is received, and transmits message information to a user when the update result exceeds a predetermined value. The message information includes a proposal to output image data to a medium.

The management of image data for each user can be performed by designating a client using predetermined user information, for example, an ID and a password, received by the print server apparatus from the home server apparatus.

The above-mentioned message information can be registered in advance so that not only the home server apparatus, but also other equipment such as a personal computer (hereinafter referred to as a PC), a personal digital assistance (PDA), a mobile phone, etc. can receive and browse the information.

The above-mentioned predetermined value can be a value corresponding to the number of frames of silver-salt film such as 24, 36, etc. as an amount appropriate for an order. An amount of image data can be a value corresponding to the capacity of a storage medium such as 64 MB (megabyte), 128 MB, etc. These values can be set for one or both of the number of pieces of image data and the amount of image data, or a plurality of values can be simultaneously set.

Proposal to output image data to a medium can include a notification that the amount of image data has reached a predetermined value, and how to place an order of output of image data.

Thus, a user can be informed that the amount of image data has reached a predetermined value without his or her own management of the image data, and can also place an order of output of image data according to the above-mentioned message, thereby quickly and easily obtaining an online service.

Furthermore, the image data of users can be managed and a proposal to output to a medium can be issued, a service provider can increase the chance to receive an order from a user.

The second aspect of the present invention is based on the first aspect of the present invention, wherein communications between the imaging apparatus and the home server apparatus are performed by wireless communications, the imaging apparatus transmits predetermined imaging apparatus information to the home server apparatus, and the home server apparatus receives image data from the imaging apparatus only when the imaging apparatus information received from the imaging apparatus matches imaging apparatus information stored in advance.

That is, since communications between the imaging apparatus and the home server apparatus are performed by wireless communications, a user can transmit image data anywhere in a coverage of the wireless communications. Additionally, since image data is transmitted only when identification information transmitted from an imaging apparatus matches identification information stored in advance in a home server apparatus, no image data is transmitted from an unauthorized equipment.

Thus, a user can much more quickly and easily use an online service, and enhance the security of the system.

The third aspect of the present invention is based on the first aspect of the present invention, and further includes a cradle apparatus capable of supplying power to the imaging apparatus, and the imaging apparatus automatically starts wireless communications with the home server apparatus when the imaging apparatus is connected to the cradle apparatus.

That is, since image data is automatically transmitted when an imaging apparatus is connected to a cradle apparatus, it is not necessary for a user to perform any operation other than connecting the imaging apparatus to the cradle apparatus when image data is transmitted.

Thus, the user can much more quickly and easily obtain an online service.

The fourth aspect of the present invention is based on the first aspect of the present invention, wherein image data transmitted by the imaging apparatus is not assigned an identifier, and the identifier is assigned to image data already transmitted to the home server apparatus from the imaging apparatus.

That is, by the imaging apparatus transmitting image data by referring to an identifier indicating the transmission status, only the image data which has not been transmitted yet can be transmitted to the home server apparatus without double transmitting already transmitted image data.

Therefore, it is not necessary for a user to check whether or not image data has already been transmitted. As a result, the user can much more quickly and easily obtain an online service.

The fifth aspect of the present invention is based on the first aspect of the present invention, wherein communications between the imaging apparatus and the home server apparatus are performed by wireless communications, the imaging apparatus transmits predetermined imaging apparatus information to the home server apparatus, and the home server apparatus receives image data from the imaging apparatus only when the imaging apparatus information received from the imaging apparatus matches imaging apparatus information stored in advance; and the imaging apparatus further includes a cradle apparatus capable of supplying power to the imaging apparatus, and the imaging apparatus automatically starts wireless communications with the home server apparatus when the imaging apparatus is connected to the cradle apparatus.

That is, since communications between the imaging apparatus and the home server apparatus are performed by wireless communications, a user can transmit image data anywhere in a coverage of the wireless communications. Additionally, since image data is transmitted only when identification information transmitted from an imaging apparatus matches identification information stored in advance in a home server apparatus, no image data is transmitted from an unauthorized equipment.

Since image data is automatically transmitted when an imaging apparatus is connected to a cradle apparatus, it is not necessary for a user to perform any operation other than connecting the imaging apparatus to the cradle apparatus when image data is transmitted.

Thus, a user can much more quickly and easily use an online service, and enhance the security of the system.

The sixth aspect of the present invention is based on the first aspect of the present invention, wherein communications between the imaging apparatus and the home server apparatus are performed by wireless communications, the imaging apparatus transmits predetermined imaging apparatus information to the home server apparatus, and the home server apparatus receives image data from the imaging apparatus only when the imaging apparatus information received from the imaging apparatus matches imaging apparatus information stored in advance; the imaging apparatus further includes a cradle apparatus capable of supplying power to the imaging apparatus, the imaging apparatus automatically starts wireless communications with the home server apparatus when the imaging apparatus is connected to the cradle apparatus; and image data transmitted by the imaging apparatus is not assigned an identifier, and the identifier is assigned to image data already transmitted to the home server apparatus from the imaging apparatus.

That is, since communications between the imaging apparatus and the home server apparatus are performed by wireless communications, a user can transmit image data anywhere in a coverage of the wireless communications. Additionally, since image data is transmitted only when identification information transmitted from an imaging apparatus matches identification information stored in advance in a home server apparatus, no image data is transmitted from an unauthorized equipment.

Since image data is automatically transmitted when an imaging apparatus is connected to a cradle apparatus, it is not necessary for a user to perform any operation other than connecting the imaging apparatus to the cradle apparatus when image data is transmitted.

Furthermore, by the imaging apparatus transmitting image data by referring to an identifier indicating the transmission status, only the image data which has not been transmitted yet can be transmitted to the home server apparatus without double transmitting already transmitted image data.

Thus, a user can much more quickly and easily use an online service, and enhance the security of the system. Additionally, the user does not have to check whether or not image data has already been transmitted.

To attain the above-mentioned object, the seventh aspect of the present invention is a print service system comprising: an imaging apparatus including: an imaging device which outputs image data of a photo image obtained by capturing an object, a first recording device which records the image data, and a first communications device which transmits the image data recorded in the first recording device to a predetermined home server apparatus; and the home server apparatus including: a second communications device which receives image data from the imaging apparatus, a second recording device which records the image data received by the second communications device, a third communications device which automatically transmits the image data recorded by the second recording device and predetermined user information to a predetermined print server apparatus, and an image data management device which manages image data recorded in the second recording device, wherein: the image data management device updates at least one of a total number of pieces of image data and a total amount of image data each time the third communications device transmits image data to the specified print server apparatus, and automatically transmits message information to equipment registered in advance when the updated result exceeds a predetermined value, wherein the message information includes a proposal to output image data to a medium from the print server apparatus.

That is, since the imaging apparatus transmits image data to a predetermined home server apparatus, and the home server apparatus receives and records image data and automatically transmits the image data to a specified print server apparatus, it is not necessary for a user to activate equipment to transmit image data, access a server apparatus on a network. And image data is not transmitted to an improper print server apparatus by an erroneous operation.

Thus, the user can quickly and easily transmit image data to a print server apparatus.

A home server apparatus updates the total number of pieces of image data of each user and the total amount of image data of each user each time image data is received, and transmits message information when the update result exceeds a predetermined value. The message information includes proposal to output image data from a print server apparatus to a medium.

The proposal to output image data to a medium included in the above-mentioned message information can be a notification that the amount of image data has reached a predetermined value, and a procedure of placing an order of the output of image data.

The above-mentioned message information can be registered in advance so that not only the home server apparatus, but also other equipment such as a personal computer (hereinafter referred to as a PC), a personal digital assistance (PDA), a mobile phone, etc. can receive and browse the information.

The above-mentioned predetermined value can be a value corresponding to the number of frames of silver-salt film such as 24, 36, etc. as an amount appropriate for an order. An amount of image data can be a value corresponding to the capacity of a storage medium such as 64 MB (megabyte), 128 MB, etc. These values can be set for one or both of the number of pieces of image data and the amount of image data, or a plurality of values can be simultaneously set.

A service provider can newly provide a print server apparatus to store and output image data, and can use an existing print server apparatus for the above-mentioned object.

Thus, a user can be informed that the amount of image data has reached a predetermined value without his or her own management of the image data, and can also place an order of output of image data according to the above-mentioned message, thereby quickly and easily obtaining an online service.

Furthermore, the image data of users can be managed and a proposal to output the image data from a print server apparatus to a medium can be issued, a service provider can increase the chance to receive an order from a user.

The eighth aspect of the present invention is based on the seventh aspect of the present invention, wherein the second recording device is either a non-volatile storage device which stores image data for a plurality of images or a volatile storage device which temporarily stores image data.

That is, when the second recording device is a non-volatile storage device for storing image data for a plurality of images, the image data can be stored in a non-volatile state. Therefore, the image data can be transmitted to a print server apparatus at any timing, or can be re-transmitted.

When the second recording device is a volatile storage device for temporarily storing image data, no large-capacity recording device for storing image data for a plurality of images is required, thereby successfully reducing the cost of the home server apparatus.

Since image data stored in the second recording device can be automatically transmitted, it is not necessary for a user to operate the home server apparatus.

The ninth aspect of the present invention is based on the seventh aspect of the present invention, wherein communications between the imaging apparatus and the home server apparatus are performed by wireless communications, the imaging apparatus transmits predetermined imaging apparatus information to the home server apparatus, and the home server apparatus receives image data from the imaging apparatus only when the imaging apparatus information received from the imaging apparatus matches imaging apparatus information stored in advance.

That is, since communications between the imaging apparatus and the home server apparatus are performed by wireless communications, a user can transmit image data anywhere in a coverage of the wireless communications. Additionally, since image data is transmitted only when identification information transmitted from an imaging apparatus matches identification information stored in advance in a home server apparatus, no image data is transmitted from an unauthorized equipment.

Thus, a user can much more quickly and easily use an online service, and enhance the security of the system.

The tenth aspect of the present invention is based on the seventh aspect of the present invention, wherein the imaging apparatus further includes a cradle apparatus capable of supplying power to the imaging apparatus, and the imaging apparatus automatically starts wireless communications with the home server apparatus when the imaging apparatus is connected to the cradle apparatus.

That is, since image data is automatically transmitted when an imaging apparatus is connected to a cradle apparatus, it is not necessary for a user to perform any operation other than connecting the imaging apparatus to the cradle apparatus when image data is transmitted.

Thus, a user can much more quickly and easily use an online service.

The eleventh aspect of the present invention is based on the seventh aspect of the present invention, wherein image data transmitted by the imaging apparatus is not assigned an identifier, and the identifier is assigned to image data already transmitted to the home server apparatus from the imaging apparatus.

That is, by the imaging apparatus transmitting image data by referring to an identifier indicating the transmission status, only the image data which has not been transmitted yet can be transmitted to the home server apparatus without double transmitting already transmitted image data.

Therefore, it is not necessary for a user to check whether or not image data has already been transmitted. As a result, the user can much more quickly and easily obtain an online service.

The twelfth aspect of the present invention is based on the seventh aspect of the present invention, wherein the second recording device is either a non-volatile storage device which stores image data for a plurality of images or a volatile storage device which temporarily stores image data; and communications between the imaging apparatus and the home server apparatus are performed by wireless communications, the imaging apparatus transmits predetermined imaging apparatus information to the home server apparatus, and the home server apparatus receives image data from the imaging apparatus only when the imaging apparatus information received from the imaging apparatus matches imaging apparatus information stored in advance.

That is, when the second recording device is a non-volatile storage device for storing image data for a plurality of images, the image data can be stored in a non-volatile state. Therefore, the image data can be transmitted to a print server apparatus at any timing, or can be re-transmitted.

When the second recording device is a volatile storage device for temporarily storing image data, no large-capacity recording device for storing image data for a plurality of images is required, thereby successfully reducing the cost of the home server apparatus.

Since image data stored in the second recording device can be automatically transmitted, it is not necessary for a user to operate the home server apparatus.

Since communications between the imaging apparatus and the home server apparatus are performed by wireless communications, a user can transmit image data anywhere in a coverage of the wireless communications. Additionally, since image data is transmitted only when identification information transmitted from an imaging apparatus matches identification information stored in advance in a home server apparatus, no image data is transmitted from an unauthorized equipment.

Thus, a user can much more quickly and easily use an online service, and enhance the security of the system.

The thirteenth aspect of the present invention is based on the seventh aspect of the present invention, wherein the second recording device is either a non-volatile storage device which stores image data for a plurality of images or a volatile storage device which temporarily stores image data; communications between the imaging apparatus and the home server apparatus are performed by wireless communications, the imaging apparatus transmits predetermined imaging apparatus information to the home server apparatus, and the home server apparatus receives image data from the imaging apparatus only when the imaging apparatus information received from the imaging apparatus matches imaging apparatus information stored in advance; and the imaging apparatus further includes a cradle apparatus capable of supplying power to the imaging apparatus, and the imaging apparatus automatically starts wireless communications with the home server apparatus when the imaging apparatus is connected to the cradle apparatus.

That is, when the second recording device is a non-volatile storage device for storing image data for a plurality of images, the image data can be stored in a non-volatile state. Therefore, the image data can be transmitted to a print server apparatus at any timing, or can be re-transmitted.

When the second recording device is a volatile storage device for temporarily storing image data, no large-capacity recording device for storing image data for a plurality of images is required, thereby successfully reducing the cost of the home server apparatus.

Since image data stored in the second recording device can be automatically transmitted, it is not necessary for a user to operate the home server apparatus.

Since communications between the imaging apparatus and the home server apparatus are performed by wireless communications, a user can transmit image data anywhere in a coverage of the wireless communications. Additionally, since image data is transmitted only when identification information transmitted from an imaging apparatus matches identification information stored in advance in a home server apparatus, no image data is transmitted from an unauthorized equipment.

Since image data is automatically transmitted when an imaging apparatus is connected to a cradle apparatus, it is not necessary for a user to perform any operation other than connecting the imaging apparatus to the cradle apparatus when image data is transmitted.

Thus, a user can much more quickly and easily use an online service, and enhance the security of the system.

The fourteenth aspect of the present invention is based on the seventh aspect of the present invention, wherein the second recording device is either a non-volatile storage device which stores image data for a plurality of images or a volatile storage device which temporarily stores image data; communications between the imaging apparatus and the home server apparatus are performed by wireless communications, the imaging apparatus transmits predetermined imaging apparatus information to the home server apparatus, and the home server apparatus receives image data from the imaging apparatus only when the imaging apparatus information received from the imaging apparatus matches imaging apparatus information stored in advance; the imaging apparatus further includes a cradle apparatus capable of supplying power to the imaging apparatus, and the imaging apparatus automatically starts wireless communications with the home server apparatus when the imaging apparatus is connected to the cradle apparatus; and image data transmitted by the imaging apparatus is not assigned an identifier, and the identifier is assigned to image data already transmitted to the home server apparatus from the imaging apparatus.

That is, when the second recording device is a non-volatile storage device for storing image data for a plurality of images, the image data can be stored in a non-volatile state. Therefore, the image data can be transmitted to a print server apparatus at any timing, or can be re-transmitted.

When the second recording device is a volatile storage device for temporarily storing image data, no large-capacity recording device for storing image data for a plurality of images is required, thereby successfully reducing the cost of the home server apparatus.

Since image data stored in the second recording device can be automatically transmitted, it is not necessary for a user to operate the home server apparatus.

Since communications between the imaging apparatus and the home server apparatus are performed by wireless communications, a user can transmit image data anywhere in a coverage of the wireless communications. Additionally, since image data is transmitted only when identification information transmitted from an imaging apparatus matches identification information stored in advance in a home server apparatus, no image data is transmitted from an unauthorized equipment.

Since image data is automatically transmitted when an imaging apparatus is connected to a cradle apparatus, it is not necessary for a user to perform any operation other than connecting the imaging apparatus to the cradle apparatus when image data is transmitted.

Furthermore, by the imaging apparatus transmitting image data by referring to an identifier indicating the transmission status, only the image data which has not been transmitted yet can be transmitted to the home server apparatus without double transmitting already transmitted image data.

Thus, a user can much more quickly and easily use an online service, and enhance the security of the system. Additionally, the user does not have to check whether or not image data has already been transmitted.

### BRIEF DESCRIPTION OF THE DRAWINGS

FIG. 1 shows the entire configuration of the print service system according to the first embodiment of the present invention;

FIG. 2 is a block diagram showing the configuration of the important portions of the print service system according to the first embodiment of the present invention;

FIG. 3 is a flowchart of the process performed using a digital camera according to the first embodiment of the present invention;

FIG. 4 shows an image of the wireless communications performed with a home server by connecting digital camera to a cradle according to the first embodiment of the present invention;

FIG. 5 shows an image of the wireless communications between a digital camera and a home server according to the first embodiment of the present invention;

FIG. 6 is a flowchart of the process performed by a home server according to the first embodiment of the present invention;

FIG. 7 is a flowchart of the process performed by a print server according to the first embodiment of the present invention;

FIG. 8 shows an example of electronic mail according to the first embodiment of the present invention;

FIG. 9 is a block diagram showing the configuration of the important portions of the print service system according to the second embodiment of the present invention;

FIG. 10 is a flowchart of the process performed by a home server according to the second embodiment of the present invention;

FIG. 11 is a flowchart of the process performed by a print server according to the second embodiment of the present invention;

FIG. 12 shows an example of electronic mail according to the second embodiment of the present invention;

FIG. 13 is a block diagram showing the configuration of the important portions of the print service system according to the third embodiment of the present invention;

FIG. 14 is a flowchart of the process performed using a digital camera according to the third embodiment of the present invention;

FIG. 15 is a flowchart of the process performed by a home server according to the third embodiment of the present invention;

FIG. 16 shows an example of electronic mail according to the third embodiment of the present invention; and

FIG. 17 is a flowchart of the process performed by a print server according to the third embodiment of the present invention.

### DETAILED DESCRIPTION OF THE PREFERRED EMBODIMENTS

The preferred embodiments of the print service system according to the present invention are described below in detail by referring to the attached drawings.

(First Embodiment)

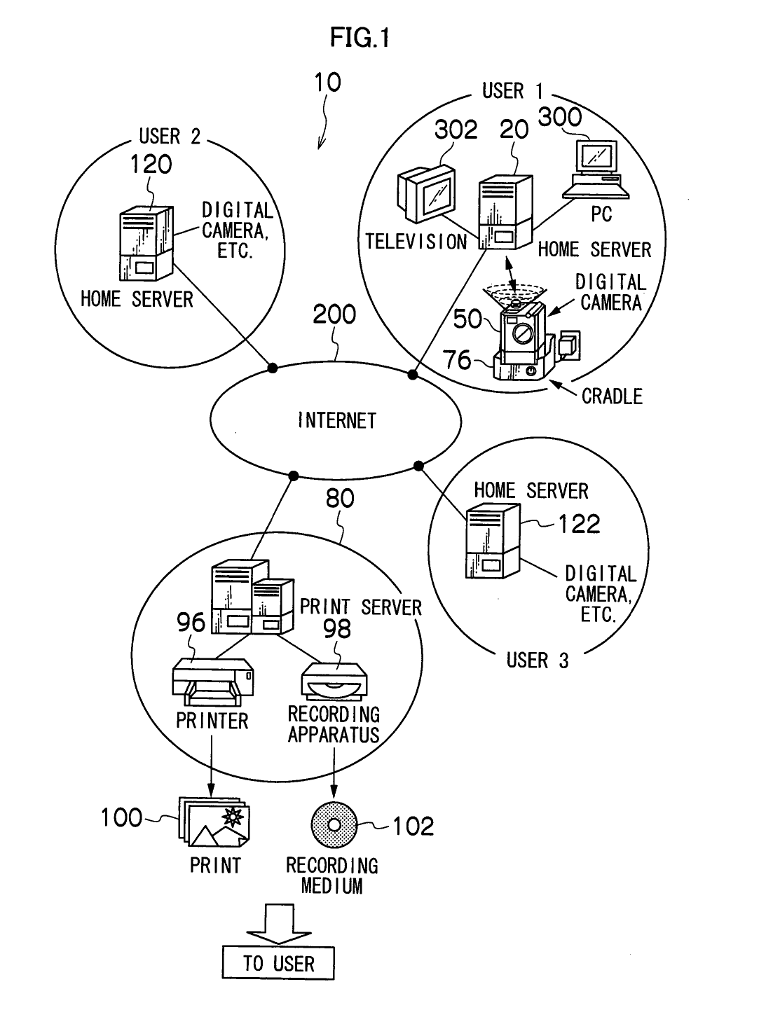

FIG. 1 shows the entire configuration of the print service system 10 according to the first embodiment of the present invention.

The print service system 10 includes a home server 20 of a user 1, a digital camera 50, a cradle 76, a home server 120 of a user 2, a home server 122 of a user 3, and a print server 80. The home server 20, the home server 120, the home server 122, and the print server 80 are connected for communications over Internet 200. The digital camera 50 and the home server 20 can perform wireless communications bidirectionally.

The print service system 10 can include one or more home server apparatuses including the home server 20, and equipment such as a digital camera, etc. can be connected to each home server apparatus. Similarly, the print service system 10 can include one or more print server apparatuses including the print server 80.

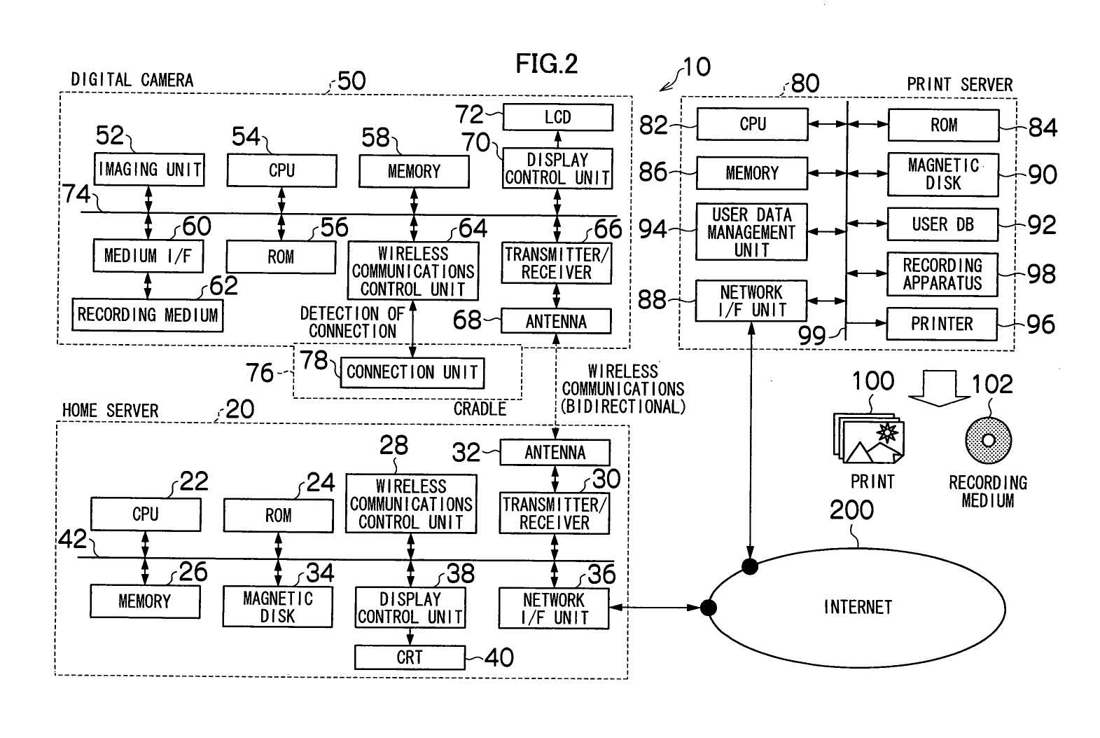

FIG. 2 shows the configuration of the important portions of the print service system 10.

First described below is the digital camera 50.

The digital camera 50 comprises an imaging unit 52. The imaging unit 52 is connected to a common bus 74, includes a lens, a CCD, etc. not shown in the attached drawings, captures an object as a still image or a moving picture, and outputs the result as image data.

Additionally, a CPU 54 for controlling the process performed by the digital camera 50, ROM 56 storing a program to be executed in the digital camera 50, a parameter, etc., memory 58 which temporarily stores image data, etc. and is used as a process area, a medium interface (“interface” is referred to as an I/F in FIG. 2 and the subsequent descriptions) 60 for controlling the record of image data, etc., a wireless communications control unit 64 for controlling the wireless communications with the home server 20, a transmitter/receiver 66 for communicating image data, connection information, etc. on a radio signal, and a display control unit 70 for controlling the display of an image, etc. on an LCD 72 are connected to a common bus 74.

Furthermore, a removable recording medium 62 is connected to the medium I/F 60, an antenna 68 for communicating a radio signal is connected to the transmitter/receiver 66, and the LCD 72 for displaying an image, etc. is connected to the display control unit 70.

The wireless communications control unit 64 stores equipment identification information indicating that the digital camera 50 is equipment allowed to perform wireless communications with the home server 20. An example of the equipment identification information can be an ID of equipment and a password.

The wireless communications control unit 64 refers to a flag when it transmits image data to the home server 20 so that only image data without a flag can be transmitted. The flag is added by the wireless communications control unit 64 to the image data which has been transmitted.

The digital camera 50 includes a button, a switch, etc. not shown in the attached drawings, and is designed to be operated by a user.

Described below is the cradle 76.

The cradle 76 includes a connection unit 78 for connection to the digital camera 50 and a power source I/F device not shown in the attached drawings, and the digital camera 50 can be connected through the connection unit 78 and supplied with electric power.

When the digital camera 50 is connected to the cradle 76, the wireless communications control unit 64 detects the connection, and automatically establishes wireless communications with the home server 20. The wireless communications can also be established by a user operating a button, a switch, etc. not shown in the attached drawings without connecting the digital camera 50 to the cradle 76.

Described below are the wireless communications to be established between the digital camera 50 and the home server 20.

A preferable system of the wireless communications can be a system in accordance with the specifications of the IEEE (Institute of Electrical and Electronics Engineers, Inc.). For example, according to the specifications of the IEEE 802.11b, radio waves in the 2.4 GHz band are used to perform wireless communications up to a distance on the order of 100 m at the maximum speed of about 11 Mbps. According to the specifications of the IEEE 802.11g, radio waves in the same 2.4 GHz band as the IEEE 802.11b are used to perform wireless communications at the maximum speed of about 54 Mbps, and maintains the upward compatibility with the specifications of the IEEE 802.11b. The specifications of the IEEE also includes the IEEE 802.11a, etc.

The system of wireless communications can also be a system based on the above-mentioned specifications of the IEEE, a system based on the conditions of a transmission distance, a communication speed, etc., that is, a system based on the specifications of Bluetooth, the infrared communications based on the specifications of IrDA.

Described below is the home server 20.

The home server 20 comprises a CPU 22 for controlling processing. The CPU 22 is connected to a common bus 42.

In addition to the CPU 22, ROM 24 storing a program to be executed by the home server 20, a parameter, etc., memory 26 which temporarily stores image data, etc. and is used as a process area, a magnetic disk 34 for storing image data and electronic mail received from the print server 80, a wireless communications control unit 28 for controlling wireless communications with the digital camera 50, a transmitter/receiver 30 for communicating image data, equipment identification information, etc. as a radio signal, the magnetic disk 34 storing image data received from the digital camera 50, and electronic mail received from the print server 80, a network I/F unit 36, and a display control unit 38 for controlling the display of image data, electronic mail, etc. are connected to the common bus 42.

The wireless communications control unit 28 stores in advance the equipment identification information (ID of equipment, a password, etc.) about equipment (including the digital camera 50) allowed to perform wireless communications with the home server 20, and receives image data only when the equipment identification information about the equipment matches the equipment identification information stored in advance.

The magnetic disk 34 stores predetermined user information such as the ID, the password, the name, the address, the mail address, of the user, so that they can be transmitted together with image data to the print server 80.

Furthermore, an antenna 32 for communicating a radio signal is connected to the transmitter/receiver 30. A CRT 40 for display of an image based on the image data received from the digital camera 50, electronic mail received from the print server 80, etc. is connected to the display control unit 38.

The network I/F unit 36 detects a communication load imposed by the equipment such as a PC 300, a television 302, etc. connected to the home server 20, and establishes communications with the print server 80 through the Internet 200 when the communication load is equal to or lower than a predetermined value.

The home server 20 includes a mouse, a keyboard, a button, a switch, etc. not shown in the attached drawings, and is designed to be operated by a user in displaying an image and electronic mail, placing an order of output of image data, etc.

As shown in FIG. 2, in addition to the digital camera 50, the PC 300 and the television 302 are connected to the home server 20, and a personal digital assistance (PDA), a mobile phone, etc. can also be connected thereto.

Described below is the print server 80.

The print server 80 comprises a CPU 82, and the CPU 82 is connected to a common bus 99.

In addition to the CPU 82, ROM 84 storing a program to be executed by the print server 80, a parameter, etc., a network I/F unit 88 for communications with the home server 20 over the Internet 200, and memory 86 which temporarily stores image data, etc. received from the home server 20, and is used as a process area are connected to the common bus 99.

Furthermore, a magnetic disk 90 storing image data for each user, a user database (“database” is referred to as a DB in FIG. 2 and the subsequent descriptions) 92, and a user data management unit 94 are connected to the common bus 99.

The user DB 92 stores information such as the ID, the password, the name, and the address of a user, the storage area of image data in the magnetic disk 90, a mail address, etc.

The user data management unit 94 controls the storage, update, etc. of the data on the magnetic disk 90 and the user DB 92, updates the total number of pieces of data and the total amount of data of the image data stored for a user each time image data of the user is received from the home server 20, and generates electronic mail when at least one of the total number of pieces of data and the total amount of data exceeds a predetermined value, and transmits the electronic mail to the user through the network I/F unit 88. The electronic mail includes the information that the amount of image data of the user has reached a predetermined value, and the information about the storage area of image data in the print server 80, and a procedure of placing an order of output of image data.

Furthermore, a printer 96 for outputting image data as a print, and a recording apparatus 98 for outputting image data to a recording medium are connected to the common bus 99.

The printer 96 can be an ink jet printer, a laser printer, a photo printer, etc. The recording apparatus 98 can be a CD-R/W drive, an MO drive, a DVD drive, etc. The image data output to a recording medium such as a CD-R/W disk, an MO disk, a DVD disk, etc. using these apparatuses can be a still image and a moving picture.

Described below is the operation of the above-mentioned embodiment.

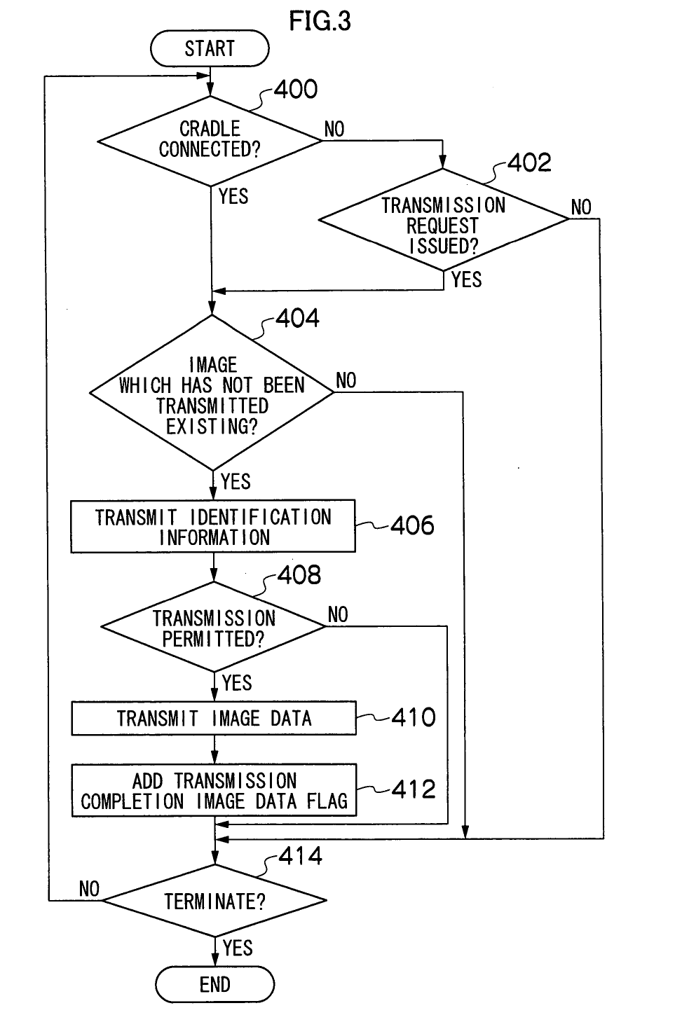

The process routine of the digital camera 50 is explained first by referring to FIG. 3.

First, in step 400, it is determined whether or not the digital camera 50 is connected to the cradle 76. If the determination result is YES, control is passed to step 404.

If the determination result is NO in step 400, then control is passed to step 402, and it is determined whether or not a request to send image data has been issued. The determination can be made by checking the presence/absence of input indicating the request to send by a button, a switch, etc. not shown in the attached drawings. If the determination result is YES, control is passed to step 404. If the determination result is NO, control is passed to step 414.

In step 404, it is determined whether or not there is an image which has not been transmitted. The determination is made by checking the presence/absence of a transmission completion flag added to image data. If the determination result is YES, control is passed to step 406. If the determination result is NO, control is passed to step 414.

In step 406, the equipment identification information about the digital camera 50 is transmitted by wireless communications to the home server 20, and control is passed to step 408.

In step 408, it is determined whether or not a permission to send image data has been received from the home server 20. If the determination result is YES, then control is passed to step 410, and image data which has not been transmitted yet is transmitted to the home server 20 by checking the flag on the image data. If a permission to send is not received, or a rejection of sending data is received, then a negative determination is made, and control is passed to step 414.

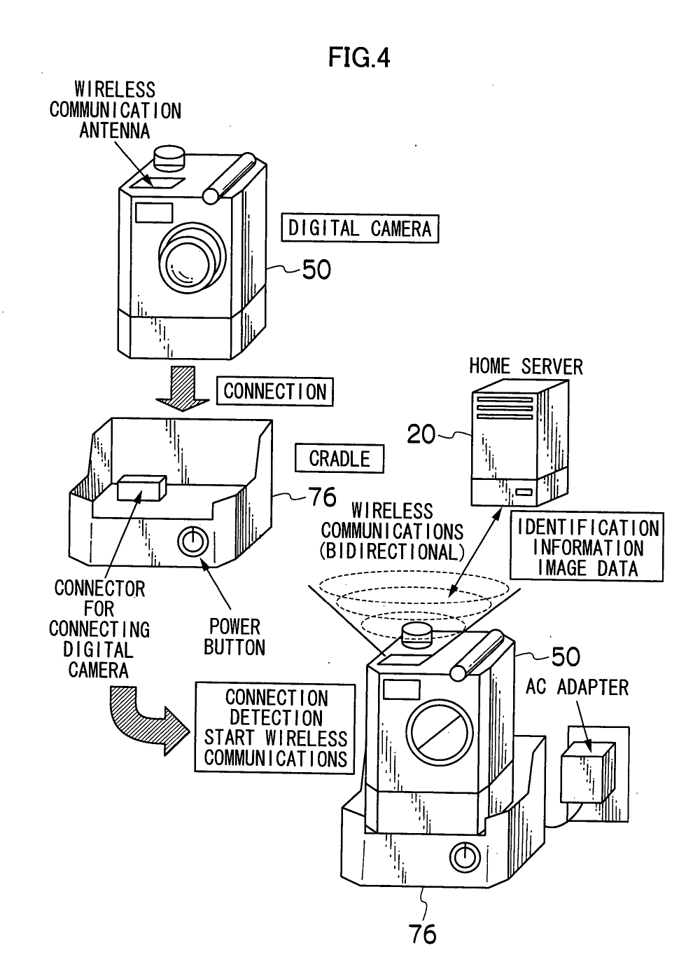

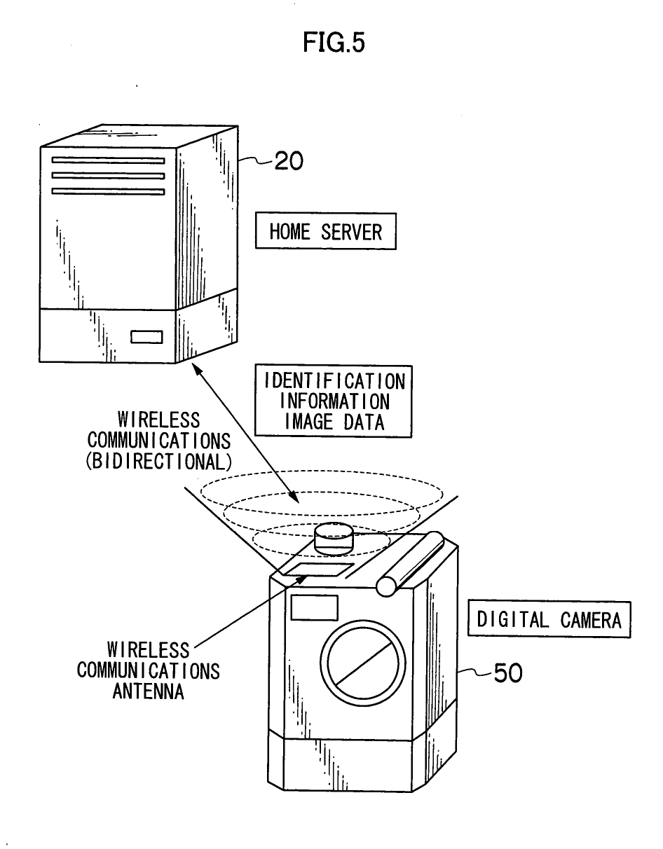

FIG. 4 shows an image of the wireless communications performed in steps 406 to 410 by connecting the digital camera 50 to the cradle 76. FIG. 5 shows an image of the operation performed using the digital camera 50.

The wireless communications can be performed according to the specifications of the IEEE, etc. as described above. When image data cannot be normally transmitted due to the trouble, etc. during the communications, the data can be re-transmitted.

In the next step 412, a transmission completion flag is added to the image data which has been transmitted to the home server 20, and then control is passed to step 414.

In step 414, it is determined whether or not the process of transferring image data is to terminate. The determination is made by checking whether or not image data which has not been transmitted has been completely transmitted. If the determination result is YES, the process routine terminates. If the determination result is NO, control is returned to step 400.

Thus, in the print service system 10, only image data which has not been transmitted yet is transmitted to the home server 20 by connecting the digital camera 50 to the cradle 76 and by a user operating the digital camera 50. As a result, the user can quickly and easily use an online print service.

Although the imaging apparatus is the digital camera 50 in the present embodiment, the imaging apparatus can be, in addition to the digital camera 50, a digital video camera capable of capturing a still image and a moving picture.

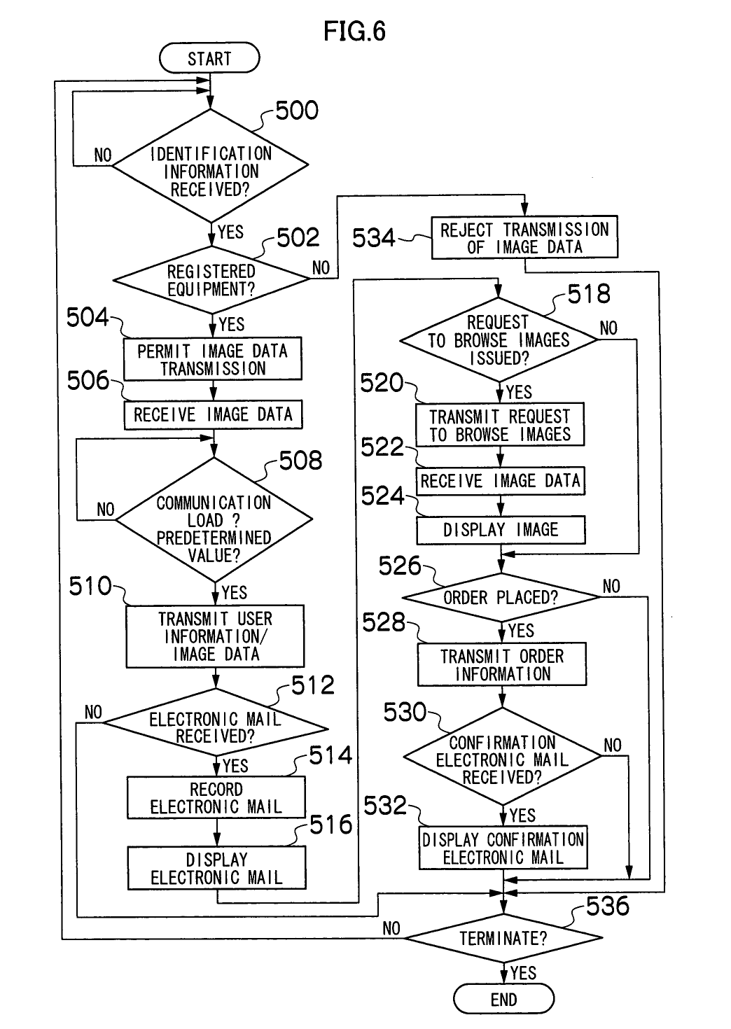

The process routine of the home server 20 is explained below by referring to FIG. 6.

First, in step 500, it is determined whether or not equipment identification information is received from the digital camera 50. A negative determination is repeated until a positive determination is made. When the determination result is NO, control is passed to step 502.

In step 502, it is determined whether or not the digital camera 50 is a registered equipment. The determination is made by checking whether or not the equipment identification information received in step 500 matches the equipment identification information stored in advance. If the determination result is YES, control is passed to step 504, and the permission to send image data is transmitted to the digital camera 50 using a radio signal. Then, in step 506, image data is received from the digital camera 50 and recorded on the magnetic disk 34, and control is passed to step 508.

If the determination result is NO in step 502, then control is passed to step 534 to transmit a rejection of sending image data to the digital camera 50 using a radio signal, and control is passed to step 536.

In step 508, a communication load imposed by the equipment such as the PC 300, the television 302, etc. connected to the home server 20 is detected, and it is determined whether or not the load is equal to or lower than a predetermined value. The negative determination is repeated until a positive determination is made. If the determination result is YES, then control is passed to step 510, and the above-mentioned user information and image data are transmitted.

If the user information and the image data cannot be normally transmitted due to any trouble, etc. in the communications, they can be re-transmitted.

Image data can be transmitted to the print server 80 each time image data for one image is received from the digital camera 50.

When user information and image data have been completely transmitted, control is passed to step 512, and it is determined whether or not electronic mail has been received from the print server 80. If the determination result is YES, then control is passed to step 514 to store the electronic mail, and the electronic mail is displayed on the CRT 40 in step 516. If no electronic mail has been received, control is passed to step 536.

The electronic mail is transmitted by the print server 80 when the amount of image data transmitted by the user has reached a predetermined value, and includes a message to prompt the output of image data, a procedure of browsing an image, a procedure of placing an order of the output of image data, a contact address of a print service provider, etc. (described later).

Since the electronic mail is transmitted (described later) to the equipment registered in advance in the print server 80, the user can register the equipment such as the PC 300, a mobile phone, a PDA, etc. in addition to the home server 20 so that the registered equipment can receive and display the electronic mail.

In step 518, it is determined whether or not there is a request to browse the images from the user related to the electronic mail. The determination is made by checking the presence/absence of the input indicating the request to browse the images using a button and a switch not shown in the attached drawings. If the determination result is YES, then control is passed to step 520 to transmit to the print server 80 the information about the image data specified in the request to browse the images, and control is then passed to step 522. If the determination result is NO, then control is passed to step 526.

In step 522, the image data transmitted by the print server 80 at the request to browse the images transmitted in step 520 is received, and control is passed to step 524 to display the image based on the image data.

The above-mentioned image can be a small amount of image data for confirmation transmitted by the print server 80, or an image based on the thumbnail image data (described later).

In the next step 526, it is determined whether or not a user has issued a request to output image data. If the determination result is YES, then control is passed to step 528 to transmit order information to the print server 80, and control is then passed to step 530. If the determination result is NO, control is passed to step 536.

The order information transmitted in step 528 can include user information such as a user ID, a password, etc., No. of output image data and the number of pieces thereof, an output format (output as a print, record of image data to a recording medium), etc.

In step 530, it is determined whether or not the confirmation electronic mail transmitted by the print server 80 has been received. If the determination result is YES, then control is passed to step 532 to display the confirmation electronic mail on the CRT 40, and control is then passed to step 536. If the determination result is NO, control is passed to step 536.

The user can check the status of the order according to the confirmation electronic mail, and can receive a print 100 on which image data is output as an image, and a recording medium 102 which records image data (described later).

The confirmation electronic mail can be received by equipment registered in advance in addition to the home server 20 as with the electronic mail described above by referring to steps 512 to 516.

In step 536, it is determined whether or not the process terminates. The determination can be made by checking the presence/absence of input indicating the termination of the process by a button, a switch, etc. not shown in the attached drawings. If the determination result is YES, the present process routine terminates. If the determination result is NO, control is passed to step 500.

Thus, in the print service system 10, the home server 20 automatically transmits image data to the print server 80. When the amount of image data has reached a predetermined value, the print server 80 transmits electronic mail to equipment such as the home server 20, etc. Since the image data received by the home server 20 is recorded on the magnetic disk 34, data can be transmitted to the print server 80 when the load is low, or data can be re-transmitted if the data has not been normally transmitted.

Thus, it is not necessary for a user to manage the user's own image data, but the user can quickly and easily use an online print service, and the image data recorded on the magnetic disk 34 can be displayed on the CRT 40 for browsing.

Furthermore, in the print service system 10, the electronic mail includes a message suggesting the output of image data, a procedure of placing an order, etc. By the print server 80 transmitting the electronic mail, there can be an increasing chance to receive an order from a user.

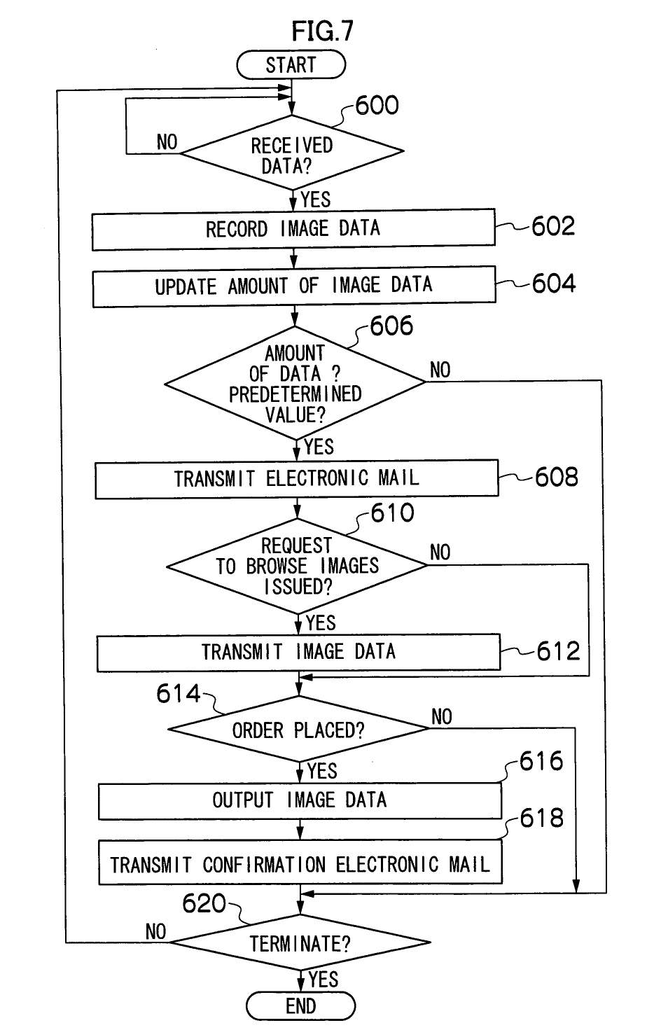

The process routine of the print server 80 is explained below by referring to FIG. 7.

First, in step 600, it is determined whether or not user information and image data have been received from the home server 20. A negative determination is repeated until a positive determination is made. If the determination result is YES, then control is passed to step 602 to record the received image data for each user specified according to the above-mentioned user information.

In the next step 604, the total number of pieces of image data and the total amount of image data recorded for the user are updated, control is passed to step 606 to determine whether or not at least one of the updated number of pieces of image data and the updated amount of image data has reached a predetermined value. If the determination result is YES, then control is passed to step 608. If the determination result is NO, control is returned to step 620.

The above-mentioned predetermined value can be set for only one of the total number of pieces of image data and the total number of pieces of image data, or can be set for both of them. Additionally, a plurality of values can be simultaneously set. These values can be set by a user.

When the total number of pieces of image data and the total amount of image data are updated, the image data can be analyzed. In this case, image data corresponding to similar images are continuously received, it is assumed that the user has mis-captured them, the plural pieces of image data are considered to be the image data of the same image with the number of pieces of image data counted as 1.

In step 608, electronic mail is transmitted to the equipment registered in advance for each user. The equipment can be the PC 300, a mobile phone, a PDA, etc. in addition to the home server 20.

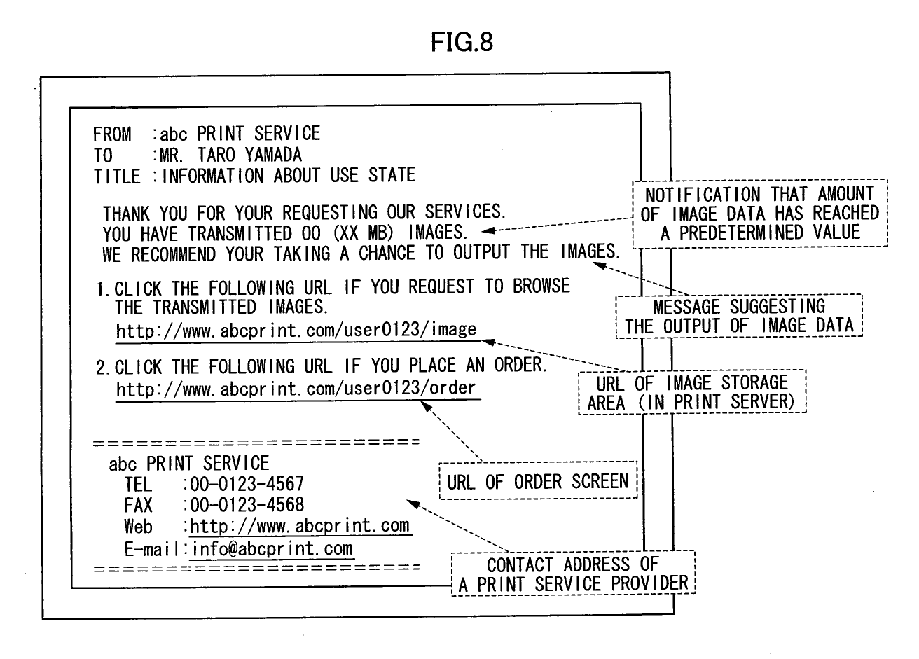

The electronic mail transmitted in step 608 includes a message suggesting the output of image data, a procedure of browsing an image, a procedure of placing an order of image data, the contact address of a print service provider, etc. as indicated by an example shown in FIG. 8.

In the next step 610, it is determined whether or not a request to browse the images has been received from the home server 20. If the determination result is YES, control is passed to step 612 to transmit the requested image data to the home server 20, and control is then passed to step 614.

If a request to browse the images is received in step 610, then the load on the home server 20, and the necessary time, etc. required in transmitting image data are considered, confirmation image data and image data of a thumbnail image which are small in the amount of data in the requested image data are generated, and then transmitted.

A thumbnail image refers to an image displayed in a list form with a plurality of images displayed in a size in which a plurality of images can be confirmed and selected.

In step 614, it is determined whether or not order information has been received from the home server 20. If the determination result is YES, then control is passed to step 616 to output image data according to the order information. If the determination result is NO, control is passed to step 620.

The output of the image data in step 616 can be the print 100 as an image, and the recording medium 102 which records image data.

When image data is output to the recording medium 102, not only the image data of a still image, but also the image data of a moving picture can be output. The recording medium 102 can be a CD-R/W disk, an MO disk, a DVD disk, etc.

In the next step 618, confirmation mail indicating the completion of an ordered product is transmitted. The confirmation mail can be transmitted to any equipment including the home server 20 registered in advance as described above.

In the next step 620, it is determined whether or not the process terminates. If the determination result is YES, the present process routine terminates. If the determination result is NO, then control is returned to step 600.

As described above, in the print service system 10 to which the present embodiment is applied, a user can be notified according to the electronic mail transmitted by the print server 80 that the amount of image data has reached a predetermined value without managing the user's own image data. Additionally, since the user can place an order according to the message which is included in the electronic mail and suggests the output of image data, the user can quickly and easily receive an online service.

Also in the print service system 10 to which the present embodiment is applied, the amount of image data of a user can be updated each time image data is received by the print server 80, and when the update result exceeds a predetermined value, the user is suggested according to electronic mail to output image data. As a result, the service provider can increase the chance to receive an order from the user.

In the print service system 10, all or a part of the services can be offered as fee-based services, or different service can be offered between free users and fee-based users. For example, there can be different storage periods and storage capacities assigned between free users and fee-based users.

(Second Embodiment)

Described below is the second embodiment of the print service system according to the present invention.

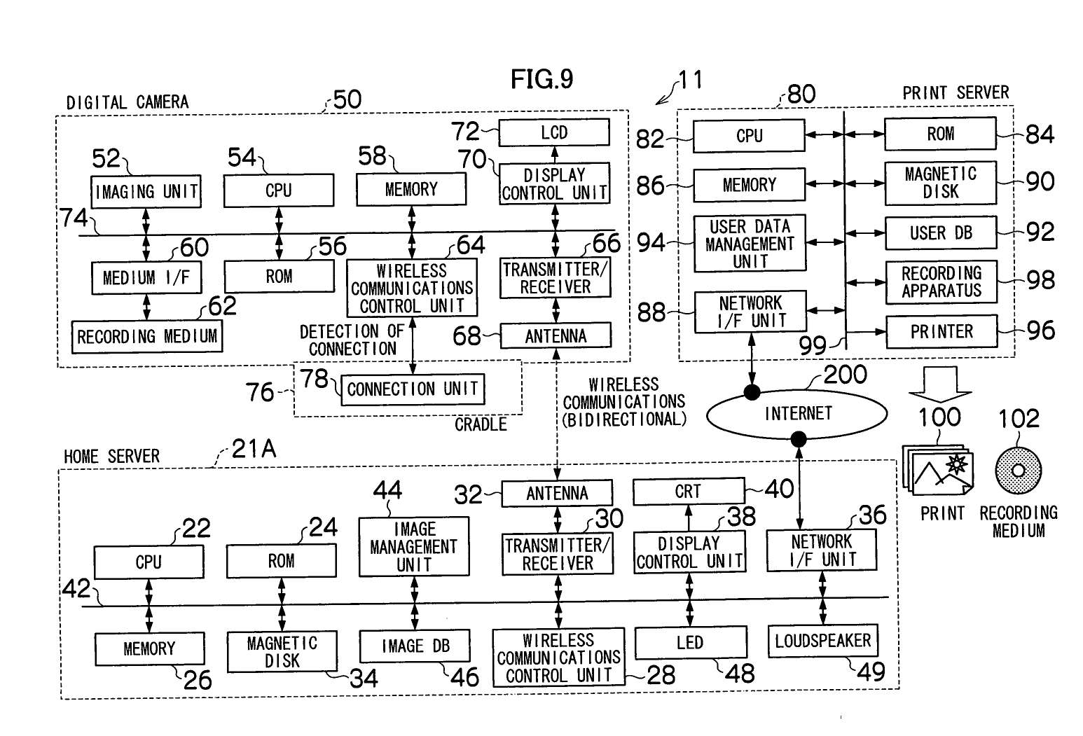

As shown in FIG. 9, a print service system 11 according to the present embodiment comprises as the important components the digital camera 50, the cradle 76, a home server 21A, and a print server 80, but the entire configuration of the system including other components is the same as the print service system 10 (FIG. 1) according to the above-mentioned first embodiment. Described below are the differences in configuration from the print service system 10 according to the first embodiment of the present invention.

In the print service system 10 according to the first embodiment, the print server 80 manages the number of pieces of image data and the amount of image data, and transmits electronic mail based on the management result. In the print service system according to the present embodiment, the home server 21A performs the above-mentioned processes. Therefore, the configurations of the home server 21A and the print server 80 are different from those according to the first embodiment. The configuration of the digital camera 50 is the same as that according to the first embodiment (FIG. 2).

The home server 21A comprises, in addition to the components of the home server 20 according to the first embodiment (FIG. 2), an image management unit 44, an image database (hereinafter referred to as an image DB) 46, an LED 48, and a loudspeaker 49 as shown in FIG. 9.

The image management unit 44 manages the record of image data on the magnetic disk 34, and the record of image data in the image DB 46. The image management unit 44 assigns a serial number for designation of each piece of image data, and records it on the magnetic disk 34. The image DB 46 stores for each piece of image data the above-mentioned serial number, the storage area of the image in the magnetic disk 34, the information indicating whether or not the data has been transmitted to the print server 80, and the information indicating whether or not a print order has been issued.

The image management unit 44 updates the total number of pieces of data and the total amount of data of the image data transmitted each time image data is transmitted to the print server 80. When at least one of the total number of pieces of data and the total amount of data exceeds a predetermined value, electronic mail is generated and transmitted to equipment registered in advance, the LED 48 is lighted or blinks, or a voice message is output from the loudspeaker 49, etc., thereby notifying a user that the amount of data has exceeded a predetermined value.

The electronic mail includes the information that the amount of image data of the user has reached a predetermined value, and the information about the storage area of image data in the home server 21A and the print server 80, and a procedure of placing an order of output of image data.

Since other configurations of the home server 21A are the same as those of the home server 20 according to the first embodiment, the same reference numerals are assigned to the same components, and overlapping explanation is omitted here.

Although the print server 80 according to the present embodiment has the same component (FIG. 2) as the print server 80 according to the first embodiment, in the print service system 11 according to the present embodiment, the home server 21A manages the number of pieces of image data and the amount of image data, and transmits the electronic mail based on the management result (as described above).

Therefore, in the print server 80, the user data management unit 94 does not manage the number of pieces of image data or the amount of image data, or transmit the electronic mail based on the management result, but controls the record, update, etc. of data on the magnetic disk 90 and in the user DB 92.

Since other configurations in the print server 80 are the same as those in the print server 80 according to the first embodiment of the present invention, the same component is assigned the same reference numeral, and the overlapping explanation is omitted here.

Described below is the operation of the present embodiment.

The process routine of the digital camera 50 is explained first by referring to FIG. 3. The process routine is the same as that of the digital camera 50 according to the first embodiment.

First, in step 400, it is determined whether or not the digital camera 50 is connected to the cradle 76. If the determination result is YES, control is passed to step 404.

If the determination result is NO in step 400, then control is passed to step 402, and it is determined whether or not a request to send image data has been issued. The determination can be made by checking the presence/absence of input indicating the request to send by a button, a switch, etc. not shown in the attached drawings. If the determination result is YES, control is passed to step 404. If the determination result is NO, control is passed to step 414.

In step 404, it is determined whether or not there is an image which has not been transmitted. The determination is made by checking the presence/absence of a transmission completion flag added to image data. If the determination result is YES, control is passed to step 406. If the determination result is NO, control is passed to step 414.

In step 406, the equipment identification information about the digital camera 50 is transmitted by wireless communications to the home server 21A, and control is passed to step 408.

In step 408, it is determined whether or not a permission to send image data has been received from the home server 21A. If the determination result is YES, then control is passed to step 410, and image data which has not been transmitted yet is transmitted to the home server 21A by checking the flag on the image. If a permission to send is not received, or a rejection of sending data is received, then a negative determination is made, and control is passed to step 414.

FIG. 4 shows an image of the wireless communications performed in steps 406 to 410 by connecting the digital camera 50 to the cradle 76. FIG. 5 shows an image of the operation performed using the digital camera 50.

As with the first embodiment of the present invention, the wireless communications can be performed according to the specifications of the IEEE, etc. as described above. When image data cannot be normally transmitted due to the trouble, etc. during the communications, the data can be re-transmitted.

In the next step 412, a transmission completion flag is added to the image data which has been transmitted to the home server 21A, and then control is passed to step 414.

In step 414, it is determined whether or not the process of transferring image data is to terminate. The determination is made by checking whether or not image data which has not been transmitted has been completely transmitted. If the determination result is YES, the process routine terminates. If the determination result is NO, control is returned to step 400.

Thus, in the print service system 11, only image data which has not been transmitted is transmitted to the home server 21A by connecting the digital camera 50 to the cradle 76 and by a user operating the digital camera 50. As a result, the user can quickly and easily use an online print service.

Although the imaging apparatus is the digital camera 50 in the present embodiment, the imaging apparatus can be, in addition to the digital camera 50, a digital video camera capable of capturing a still image and a moving picture.

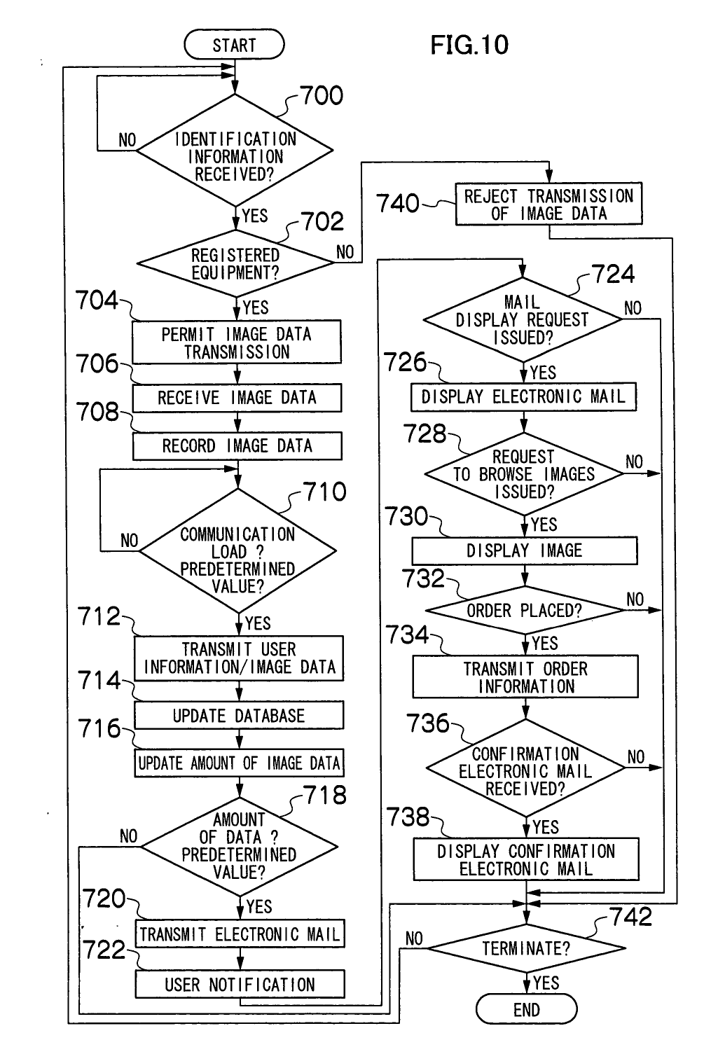

The process routine of the home server 21A is explained below by referring to FIG. 10.

First, in step 700, it is determined whether or not equipment identification information is received from the digital camera 50. A negative determination is repeated until a positive determination is made. When the determination result is YES, control is passed to step 702.

In step 702, it is determined whether or not the digital camera 50 is a registered equipment. The determination is made by checking whether or not the equipment identification information received in step 700 matches the equipment identification information stored in advance. If the determination result is YES, control is passed to step 704, and the permission to send image data is transmitted to the digital camera 50 using a radio signal. Then, in step 706, image data is received from the digital camera 50 and recorded on the magnetic disk 34 in step 708, and control is passed to step 710.

If the determination result is NO in step 702, then control is passed to step 740 to transmit a rejection of sending image data to the digital camera 50 using a radio signal, and control is passed to step 742.

In step 710, a communication load imposed by the equipment such as the PC 300, the television 302, etc. connected to the home server 21A is detected, and it is determined whether or not the load is equal to or lower than a predetermined value. The negative determination is repeated until a positive determination is made. If the determination result is YES, then control is passed to step 712, and the above-mentioned user information and image data are transmitted.

User information includes an ID, a password, the name and address, the mail address, etc. of a user, and is used in designating the user and accepting an order in the home server 21A.

If the user information and the image data cannot be normally transmitted due to any trouble, etc. in the communications, they can be re-transmitted.

Image data can be transmitted to the print server 80 each time image data for one image is received from the digital camera 50.

In the next step 712, the contents of the image DB 46, that is, the serial number, the storage area of the image in the magnetic disk 34, and the transmission completion information to the print server 80 about the transmitted image data, are updated, and then control is passed to step 716.

In step 716, the total of number of pieces of image data and the total of amount of image data are updated, control is passed to step 718, and it is determined whether or not at least one of the number of pieces of image data and the amount of image data updated as described above has reached a predetermined value. If the determination result is YES, control is passed to step 720. If the determination result is NO, control is passed to step 742.

The above-mentioned predetermined value can be set for only one of the total number of pieces of image data and the total number of pieces of image data, or can be set for both of them. Additionally, a plurality of values can be simultaneously set. These values can be set by a user.

When the total number of pieces of image data and the total amount of image data are updated, the image data can be analyzed. In this case, image data corresponding to similar images are continuously received, it is assumed that the user has mis-captured them, the plural pieces of image data are considered to be the image data of the same image with the number of pieces of image data counted as 1.

In step 720, electronic mail is transmitted to the equipment registered in advance. The equipment can be the PC 300, a mobile phone, a PDA, etc. in addition to the home server 21A.

Therefore, the user can register in advance the equipment such as the PC 300, a mobile phone, a PDA, etc. in addition to the home server 21A so that the registered equipment can receive and display the electronic mail.

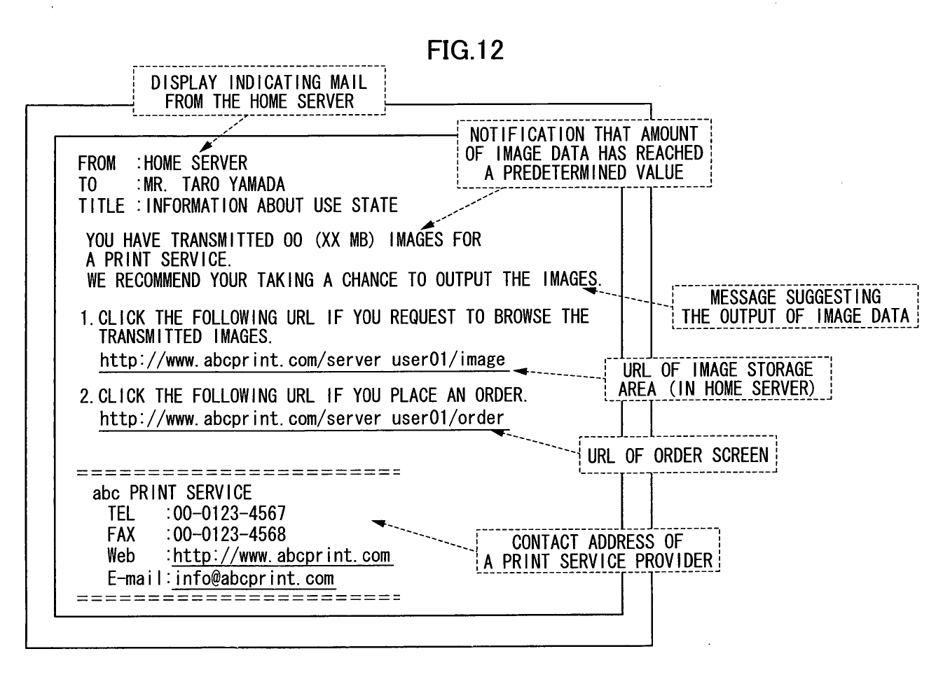

The electronic mail transmitted in step 720 includes a message suggesting the output of image data, a method of browsing an image, a procedure of placing an order of image data, the contact address of a print service provider, etc. as indicated by an example shown in FIG. 12.

In the next step 722, the user is notified by the lighted and blinking LED 48 or a voice message output from the loudspeaker 49 that the number of pieces of image data transmitted to the print server 80 has reached a predetermined value, and electronic mail has transmitted. Although a user may not be aware of the transmitted electronic mail, the LED 48 and the loudspeaker 49 can attract the attention of the user.

In the next step 724, it is determined whether or not a display request for the electronic mail has been issued. If the determination result is YES, control is passed to step 726 to display electronic mail on the CRT 40. If the determination result is NO, control is passed to step 742.

In the next step 728, it is determined whether or not a request to browse the images has been issued from the user in response to the electronic mail. The determination can be made depending on the presence/absence of the input indicating the request using a button and a switch not shown in the attached drawings. If the determination result is YES, control is passed to step 730, and based on the contents of the image DB 46, an image corresponding to the image data specified in the request to browse the images is displayed on the CRT 40. If the determination result is NO, control is passed to step 742.

The above-mentioned image can be based on confirmation image data of a small amount of data, or based on thumbnail image data. A thumbnail image refers to an image displayed in a list form with a plurality of images displayed in a size in which a plurality of images can be confirmed and selected.

Although an image is displayed based on the contents of the image DB 46 according to the explanation above, an image display request can be transmitted to the print server 80, and an image can be displayed based on the request result.

In the next step 732, it is determined whether or not an image data output request has been issued from the user. If the determination result is YES, control is passed to step 734 to transmit order information to the print server 80, and control is then passed to step 736. If the determination result is NO, control is passed to step 742.

The order information transmitted in step 734 can include user information such as a user ID, a password, etc., output image data and the number of pieces thereof, an output format (output as a print, record of image data to a recording medium), etc.

In step 736, it is determined whether or not the confirmation electronic mail transmitted by the print server 80 has been received. If the determination result is YES, then control is passed to step 738 to display the confirmation electronic mail on the CRT 40, and control is then passed to step 742. If the determination result is NO, control is passed to step 742 without performing the process in step 738.

The user can check the status of the order according to the confirmation electronic mail, and can receive a print 100 on which image data is output as an image, and a recording medium 102 which records image data corresponding to a still image and a moving picture (described later).

The confirmation electronic mail can be received by equipment registered in advance in addition to the home server 21A as with the electronic mail described above by referring to step 720.

In step 742, it is determined whether or not the process terminates. The determination can be made by checking the presence/absence of input indicating the termination of the process by a button, a switch, etc. not shown in the attached drawings. If the determination result is YES, the present process routine terminates. If the determination result is NO, control is passed to step 700.

Thus, in the print service system 11, since the image data received by the home server 21A is recorded on the magnetic disk 34, data can be transmitted to the print server 80 when the load is low, or data can be re-transmitted if the data has not been normally transmitted.

The home server 21A automatically transmits image data to the print server 80, manages image data, and transmits electronic mail to equipment registered in advance when the number of pieces or the amount of image data reaches a predetermined value so that the user can be notified of it using the LED 48 and the loudspeaker 49.

Thus, it is not necessary for a user to manage image data himself or herself, but the user can quickly and easily use an online print service, and the image data recorded on the magnetic disk 34 can be displayed on the CRT 40 for browsing.

Furthermore, in the print service system 11, the electronic mail includes a message suggesting the output of image data, a procedure of placing an order, etc. By the home server 21A transmitting the electronic mail, there can be an increasing chance for a service provider to receive an order from a user.

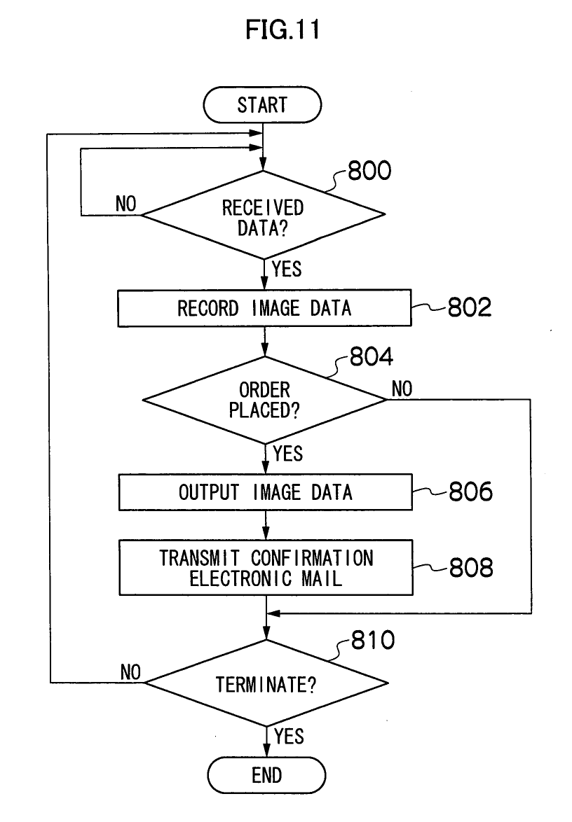

The process routine of the print server 80 is explained below by referring to FIG. 11.

First, in step 800, it is determined whether or not user information and image data have been received from the home server 21A. A negative determination is repeated until a positive determination is made. If the determination result is YES, then control is passed to step 802 to record the received image data for each user specified according to the above-mentioned user information.

The image data transmitted by a user is stored in both home server 21A and print server 80. Therefore, a user can browse the images based on the image data stored in the home server 21A or based on the request to browse the images issued from the home server 21A to the print server 80.

In this case, the print server 80 can transmit image data to the home server 21A at the request, or transmit the storage area of image data in the print server 80 to the home server 21A.

When image data is transmitted to the home server 21A, then the load on the home server 21A, and the necessary time, etc. required in transmitting image data are considered, confirmation image data and image data of a thumbnail image which are small in the amount of data in the requested image data are generated, and then transmitted.

A thumbnail image refers to an image displayed in a list form with a plurality of images displayed in a size in which a plurality of images can be confirmed and selected.

In step 804, it is determined whether or not order information has been received from the home server 21A. If the determination result is YES, then control is passed to step 806 to output image data according to the order information. If the determination result is NO, control is passed to step 810.

The order information transmitted from the home server 21A can include user information such as a user ID, a password, etc., output image data and the number of pieces thereof, an output format (output as a print, record of image data to a recording medium), etc. According to the order information, the image data is output.

The image data in step 806 can be output to the print 100 as an image, and the recording medium 102 storing image data.

When image data is output to the recording medium 102, not only the image data of a still image, but also the image data of a moving picture can be output. The recording medium 102 can be a CD-R/W disk, an MO disk, a DVD disk, etc.

In the next step 808, confirmation mail indicating the completion of an ordered product is transmitted to the home server 21A. The confirmation mail can be transmitted to any equipment including the home server 21A registered in advance as described above.

In the next step 810, it is determined whether or not the process terminates. If the determination result is YES, the present process routine terminates. If the determination result is NO, then control is returned to step 800.

As described above, in the print service system 11 to which the present embodiment is applied, the home server 21A can notify according to electronic mail, the LED 48, and the loudspeaker 49 that the total amount of data has reached a predetermined value, and place an order of output of image data according to the electronic mail. Therefore, it is not necessary for a user to manage image data himself or herself, but the user can quickly and easily use an online service.

Also in the print service system 11 to which the present embodiment is applied, the amount of image data of a user can be updated each time image data is transmitted by the home server 21A, and when the update result exceeds a predetermined value, the user is suggested according to electronic mail to output image data. As a result, the service provider can increase the chance to receive an order from the user.

In the print service system 11, all or a part of the services can be offered as fee-based services, or different service can be offered between free users and fee-based users. For example, there can be different storage periods and storage capacities assigned between free users and fee-based users.

(Third Embodiment)

Described below is the third embodiment of the print service system according to the present invention.

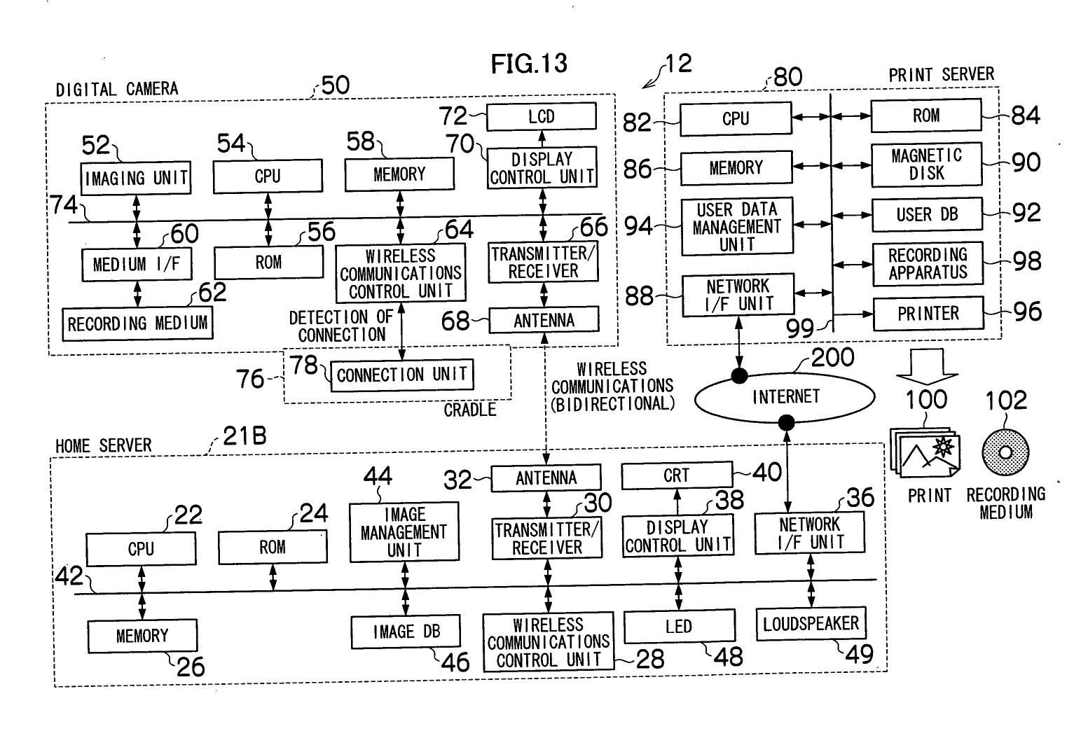

As shown in FIG. 13, a print service system 12 according to the present embodiment comprises as the important components the digital camera 50, the cradle 76, a home server 21B, and a print server 80, but the entire configuration of the system including other components is the same as the print service system 10 (FIG. 1) according to the above-mentioned first embodiment and the print service system 11 according to the second embodiment. Described below are the differences in configuration from the print service system 10 and the print service system 11.

In the print service system 10 according to the first embodiment, the print server 80 manages the number of pieces of image data and the amount of image data, and transmits electronic mail based on the management result. In the print service system 12 according to the present embodiment, the home server 21B performs the above-mentioned processes as in the second embodiment. Therefore, the configurations of the home server 21B and the print server 80 are different from those according to the first embodiment. The configuration of the digital camera 50 is the same as that according to the first and second embodiments.

The home server 21B comprises, in addition to the components of the home server 20 according to the first embodiment, the image management unit 44, the image database (hereinafter referred to as an image DB) 46, the LED 48, and the loudspeaker 49 as shown in FIG. 13. This configuration is the same as that of the home server 21A according to the second embodiment.

The image management unit 44 manages the record of image data in the image DB 46. The image DB 46 stores for each piece of image data the serial number, the information indicating whether or not the data has been transmitted to the print server 80, and the information indicating whether or not a print order has been issued.

The image management unit 44 updates the total number of pieces of data and the total amount of data of the image data transmitted each time image data is transmitted to the print server 80. When at least one of the total number of pieces of data and the total amount of data exceeds a predetermined value, electronic mail is generated and transmitted to equipment registered in advance, the LED 48 is lighted or blinks, or a voice message is output from the loudspeaker 49, etc., thereby notifying a user that the amount of data has exceeded a predetermined value.

The electronic mail includes the information that the amount of image data of the user has reached a predetermined value, and the information about the storage area of image data in the print server 80, and a procedure of placing an order of output of image data.

The home server 21B according to the present embodiment has no magnetic disk, and the memory 26 is used as a temporary storage area and a process area in transmitting image data for one image, user information, etc. to the print server 80. This configuration is different from that of the home server 21A according to the second embodiment of the present invention.

Since other configurations of the home server 21B are the same as those of the home server 20 according to the first embodiment and the home server 21A according to the second embodiment, the same reference numerals are assigned to the same components, and overlapping explanation is omitted here.

Although the print server 80 according to the present embodiment has the same component as the print server 80 according to the first embodiment, the home server 21B manages the number of pieces of image data and the amount of image data, and transmits the electronic mail based on the management result in the according to the present embodiment as with the print service system 11 according to the second embodiment.

Therefore, in the print server 80 according to the present embodiment, as with the print server 80 according to the second embodiment, the user data management unit 94 does not manage the number of pieces of image data or the amount of image data, or transmit the electronic mail based on the management result, but controls the record, update, etc. of data on the magnetic disk 90 and in the user DB 92.

Since other configurations in the print server 80 are the same as those in the print server 80 according to the first and second embodiments of the present invention, the same component is assigned the same reference numeral, and the overlapping explanation is omitted here.

Described below is the operation of the present embodiment.

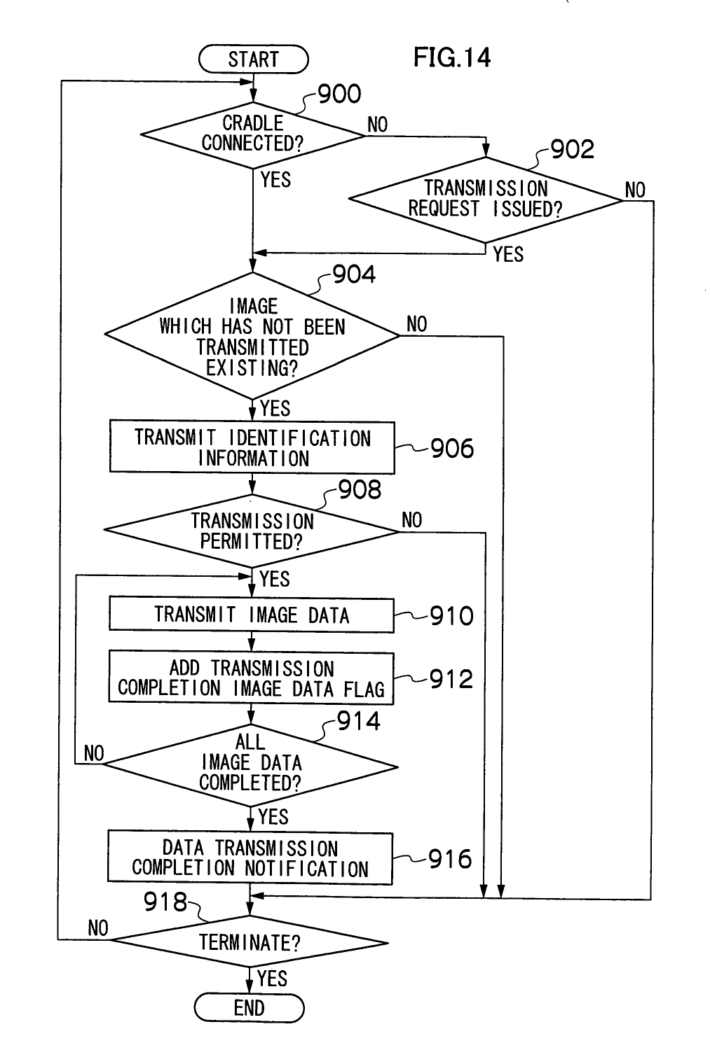

The process routine of the digital camera 50 is explained first by referring to FIG. 14. In the print service system 12 according to the present embodiment, the home server 21B has no magnetic disk, and repeatedly transmits image data in an image unit using the memory 26. Therefore, the process routine of the digital camera 50 according to the present embodiment is different from the process routine of the digital camera 50 according to the first embodiment and the process routine of the digital camera 50 according to the second embodiment (FIG. 3).

First, in step 900, it is determined whether or not the digital camera 50 is connected to the cradle 76. If the determination result is YES, control is passed to step 904.

If the determination result is NO in step 900, then control is passed to step 902, and it is determined whether or not a request to send image data has been issued. The determination can be made by checking the presence/absence of input indicating the request to send by a button, a switch, etc. of digital camera 50 not shown in the attached drawings. If the determination result is YES, control is passed to step 904. If the determination result is NO, control is passed to step 918.

In step 904, it is determined whether or not there is an image which has not been transmitted. The determination is made by checking the presence/absence of a transmission completion flag added to image data. If the determination result is YES, control is passed to step 906. If the determination result is NO, control is passed to step 918.

In step 906, the equipment identification information about the digital camera 50 is transmitted by wireless communications to the home server 21B, and control is passed to step 908.

In step 908, it is determined whether or not a permission to send image data has been received from the home server 21B. If the determination result is YES, then control is passed to step 910, and image data for an image which has not been transmitted yet is transmitted to the home server 21B by checking the flag on the image.

If a permission to send is not received, or a rejection of sending data is received, then a negative determination is made, and control is passed to step 918. As with the first and second embodiments of the present invention, the wireless communications can be performed according to the specifications of the IEEE, etc. as described above. When image data cannot be normally transmitted due to the trouble, etc. during the communications, the data can be re-transmitted.

In the next step 912, a transmission completion flag is added to the image data which has been transmitted to the home server 21B, and then control is passed to step 914.

In step 914, it is determined whether or not the process of transferring image data is to complete. If the determination result is YES, then control is passed to step 916, an image data transmission completion notification is transmitted to the home server 21B. If the determination result is NO, then control is returned to step 910, and the transmission of image data is repeated.

The images when the digital camera 50 is connected to the cradle 76 and wireless communications are performed in steps 906 to 916, and the images when wireless communications are performed by the operation of the digital camera 50 in steps 906 to 916 are as shown in FIGS. 4 and 5.

In step 918, it is determined whether or not the process is to terminate. If the determination result is YES, the process routine terminates. If the determination result is NO, control is returned to step 900.

Thus, in the print service system 12, as in the first and second embodiments, only image data which has not been transmitted is transmitted to the home server 21B by connecting the digital camera 50 to the cradle 76, or by a user operating the digital camera 50. As a result, the user can quickly and easily use an online print service.

The imaging apparatus according to the present embodiment can be, in addition to the digital camera 50, a digital video camera capable of capturing a still image and a moving picture.

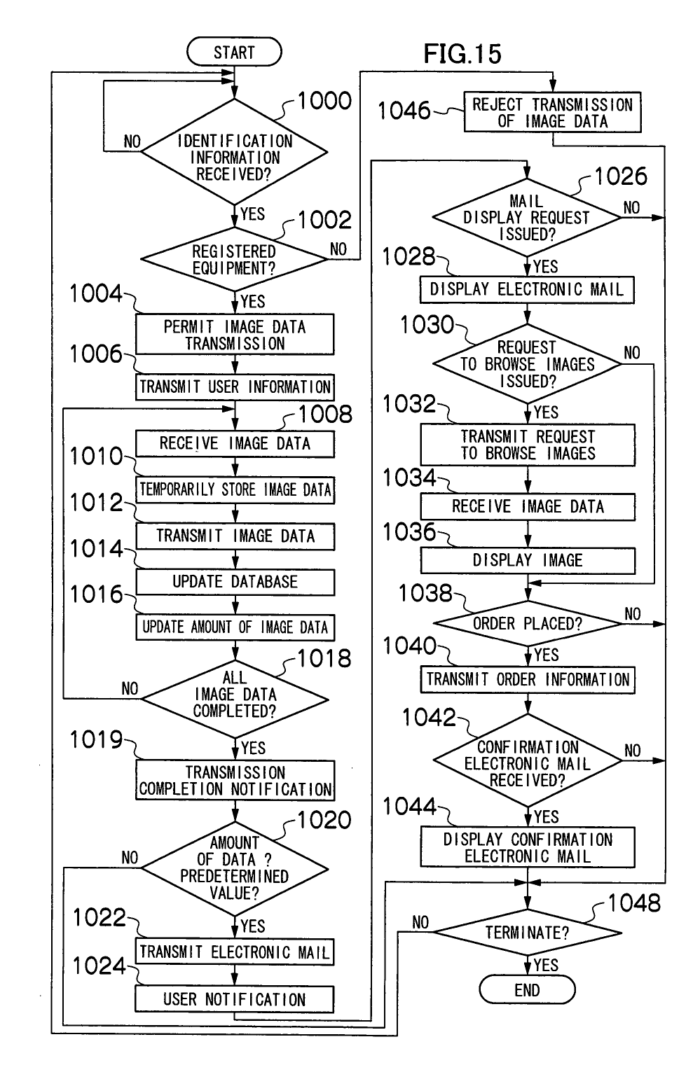

The process routine of the home server 21B is explained below by referring to FIG. 15.

First, in step 1000, it is determined whether or not equipment identification information is received from the digital camera 50. A negative determination is repeated until a positive determination is made. When the determination result is YES, control is passed to step 1002.

In step 1002, it is determined whether or not the digital camera 50 is a registered equipment. The determination is made by checking whether or not the equipment identification information received in step 1000 matches the equipment identification information stored in advance. If the determination result is YES, then control is passed to step 1004, a permission to transmit image data is transmitted to the digital camera 50 using a radio signal, and control is passed to step 1006 to transmit user information to the print server 80. If the determination result is NO, then control is passed to step 1046, a rejection of transmitting image data is transmitted to the digital camera 50 using a radio signal, and control is passed to step 1048.

User information includes an ID, a password, the name and address, the mail address, etc. of a user, and is used in designating the user and accepting an order.

In step 1008, image data for one image is received from the digital camera 50. In step 1010, the image data is temporarily stored in the memory 26. Then, in step 1012, the image data is transmitted to the print server 80.

In the next step 1014, the content of the image DB 46, that is, the transmission status of the image data, is updated to “transmission completed” based on the transmission result in step 1012. Then, in step 1016, the total amount of image data is updated.

In step 1018, it is determined whether or not the reception of the image data from the digital camera 50 has been completed. The determination can be made by checking whether or not a transmission completion notification has been received from the digital camera 50. If the determination result is YES, an image data transmission completion notification is issued to the print server 80 in step 1019, and then control is passed to step 1020. If the determination result is NO, control is returned to step 1008, and the reception of image data is repeated.

In steps 1006 and 1012, the communication load imposed by the equipment such as the PC 300, the television 302, etc. connected to the home server 211B can be detected to transmit the user information and image data by checking whether or not the load is equal to or lower than a predetermined value.

If the user information and the image data cannot be normally transmitted due to any trouble, etc. in the communications, they can be re-transmitted.

In step 1020, it is determined whether or not the total amount of image data has exceeded a predetermined value. If the determination result is YES, then control is passed to step 1022. If the determination result is NO, then control is passed to step 1048.

The above-mentioned predetermined value can be set for only one of the total number of pieces of image data and the total number of pieces of image data, or can be set for both of them. Additionally, a plurality of values can be simultaneously set. These values can be set by a user.

When the total number of pieces of image data and the total amount of image data are updated, the image data can be analyzed. In this case, image data corresponding to similar images are continuously received, it is assumed that the user has mis-captured them, the plural pieces of image data are considered to be the image data of the same image with the number of pieces of image data counted as 1.

In step 1022, electronic mail is transmitted to the equipment registered in advance. The equipment can be the PC 300, a mobile phone, a PDA, etc. in addition to the home server 21B.

Therefore, the user can register in advance the equipment such as the PC 300, a mobile phone, a PDA, etc. in addition to the home server 21B so that the registered equipment can receive and display the electronic mail.

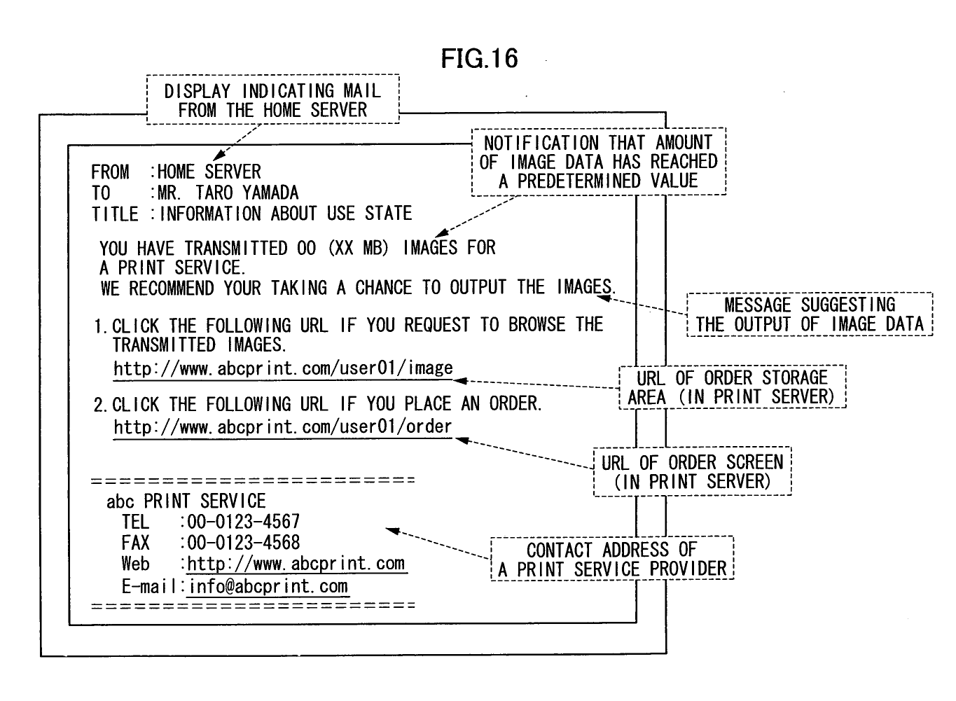

The electronic mail transmitted in step 1022 includes a message suggesting the output of image data, a method of browsing an image, a procedure of placing an order of image data, the contact address of a print service provider, etc. as in the first and second embodiments (See FIG. 16).

In the next step 1024, the user is notified by the lighted and blinking LED 48 or a voice message output from the loudspeaker 49 that the number of pieces of image data transmitted to the print server 80 has reached a predetermined value, and the home server 21B has transmitted electronic mail. Although a user may not be aware of the transmitted electronic mail, the LED 48 and the loudspeaker 49 can attract the attention of the user.

In the next step 1026, it is determined whether or not a display request for the electronic mail has been issued. If the determination result is YES, control is passed to step 1028 to display electronic mail on the CRT 40. If the determination result is NO, control is passed to step 1048.

In the next step 1030, it is determined whether or not a request to browse the images has been issued from the user in response to the electronic mail. The determination can be made depending on the presence/absence of the input indicating the request using a button and a switch not shown in the attached drawings. If the determination result is YES, control is passed to step 1032 to transmit a request to browse the images to the print server 80. If the determination result is NO, control is passed to step 1038.

In step 1034, image data is received from the print server 80. In step 1036, an image based on the image data is displayed on the CRT 40.

The image data can be received and displayed for each image, or thumbnail image data can be received to display an image based on the received data (described later).

A thumbnail image refers to an image displayed in a list form with a plurality of images displayed in a size in which a plurality of images can be confirmed and selected. When the image data is received and displayed for each image, confirmation image data of a smaller amount of data can be received and displayed.

In the next step 1038, it is determined whether or not an image data output request has been issued from the user. If the determination result is YES, control is passed to step 1040 to transmit order information to the print server 80, and control is then passed to step 1042. If the determination result is NO, control is passed to step 1048.

The order information transmitted in step 1040 can include user information such as a user ID, a password, etc., output image data and the number of pieces thereof, an output format (output as a print, record of image data to a recording medium), etc.

In step 1042, it is determined whether or not the confirmation electronic mail transmitted by the print server 80 has been received. If the determination result is YES, then control is passed to step 1044 to display the confirmation electronic mail on the CRT 40, and control is then passed to step 1048. If the determination result is NO, control is passed to step 1048 without performing the process in step 1044.

The user can check the status of the order according to the confirmation electronic mail, and can receive a print 100 on which image data is output as an image, and a recording medium 102 which records image data corresponding to a still image and a moving picture (described later).

The confirmation electronic mail can be received by equipment registered in advance in addition to the home server 21B as with the electronic mail described above by referring to step 1022.

In step 1048, it is determined whether or not the process terminates. The determination can be made by checking the presence/absence of input indicating the termination of the process by a button, a switch, etc. not shown in the attached drawings. If the determination result is YES, the present process routine terminates. If the determination result is NO, control is passed to step 1000.

Thus, in the print service system 12, the home server 21B automatically transmits image data to the print server 80, manages image data, and transmits electronic mail to equipment registered in advance when the number of pieces or the amount of image data reaches a predetermined value so that the user can be notified of it using the LED 48 and the loudspeaker 49.

Therefore, it is not necessary for a user to manage image data himself or herself, but the user can quickly and easily use an online print service.

Furthermore, in the print service system 12, the electronic mail includes a message suggesting the output of image data, a procedure of placing an order, etc. By the home server 21B transmitting the electronic mail, there can be an increasing chance for a service provider to receive an order from a user.

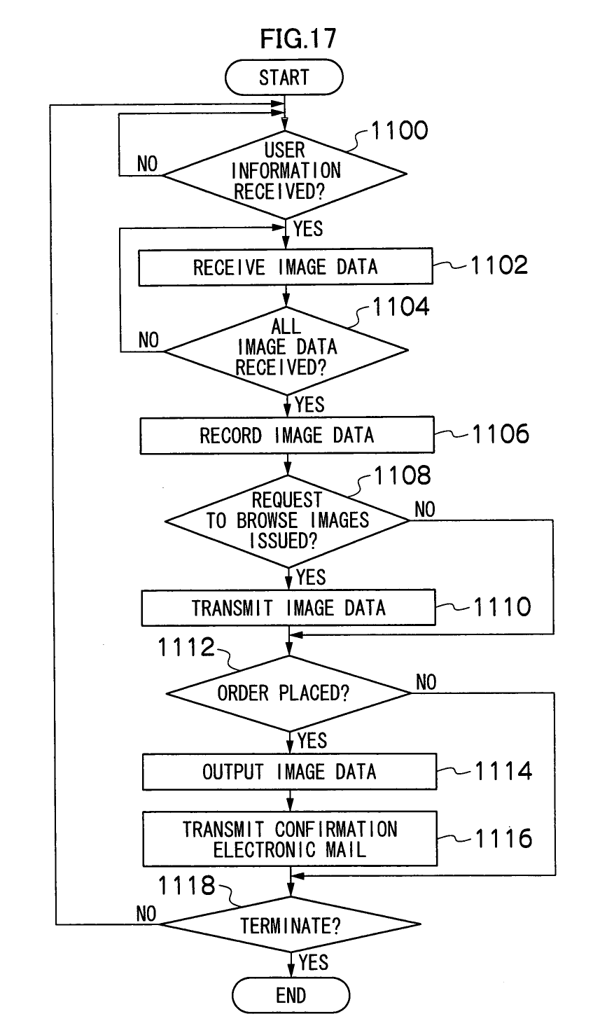

The process routine of the print server 80 is explained below by referring to FIG. 17.

First, in step 1100, it is determined whether or not user information has been received from the home server 21B. A negative determination is repeated until a positive determination is made. If the determination result is YES, then control is passed to step 1102 to receive image data for one image from the home server 21B.

In the next step 1104, it is determined whether or not all image data has been received. The determination can be made by checking the presence/absence of the reception of an image data transmission completion notification from the home server 21B. If the determination result is YES, then control is passed to step 1106 to store the image data received in step 1102 for each user specified by the user information. If the determination result is NO, then control is returned to step 1102, and the reception of image data is repeated.

In step 1108, it is determined whether or not a request to browse the images has been received from the home server 21B. If the determination result is YES, then control is passed to step 110 to transmit the image data of the requested image to the home server 21B. Then, control is passed to step 1112. If the determination result is NO, then control is passed to step 1112 without performing the process in step 1110.

The image data can be received and displayed for each image, or thumbnail image data can be generated and transmitted. When the image data is generated and transmitted for each image, confirmation image data of a smaller amount of data can be transmitted.

In step 1112, it is determined whether or not order information has been received from the home server 21B. If the determination result is YES, then control is passed to step 1114 to output image data according to the order information. If the determination result is NO, control is passed to step 1118.

The order information transmitted from the home server 21B can include user information such as a user ID, a password, etc., output image data and the number of pieces thereof, an output format (output as a print, record of image data to a recording medium), etc. According to the order information, the image data is output.

The image data in step 1114 can be output to the print 100 as an image, and the recording medium 102 storing image data.

When image data is output to the recording medium 102, not only the image data of a still image, but also the image data of a moving picture can be output. The recording medium 102 can be a CD-R/W disk, an MO disk, a DVD disk, etc.

In the next step 1116, confirmation mail indicating the completion of an ordered product is transmitted to the home server 21B. The confirmation mail can be transmitted to any equipment including the home server 21B registered in advance as described above.

In the next step 1118, it is determined whether or not the process terminates. If the determination result is YES, the present process routine terminates. If the determination result is NO, then control is returned to step 1100.

As described above, in the print service system 12 to which the present embodiment is applied, the home server 21B can notify according to electronic mail, the LED 48, and the loudspeaker 49 that the total amount of data has reached a predetermined value, and place an order of output of image data according to the electronic mail. Therefore, it is not necessary for a user to manage image data himself or herself, but the user can quickly and easily use an online service.

Also in the print service system 12 to which the present embodiment is applied, the amount of image data of a user can be updated each time image data is transmitted by the home server 21B, and when the update result exceeds a predetermined value, the user is suggested according to electronic mail to output image data. As a result, the service provider can increase the chance to receive an order from the user.

In the print service system 12, all or a part of the services can be offered as fee-based services, or different service can be offered between free users and fee-based users. For example, there can be different storage periods and storage capacities assigned between free users and fee-based users.

What is claimed is:

1. A print service system, comprising:
an imaging apparatus including: an imaging device which outputs image data of a photo image obtained by capturing an object, a first recording device which records the image data, and a first communications device which transmits the image data recorded in said first recording device to a predetermined home server apparatus;
the predetermined home server apparatus including: a second communications device which receives image data from said imaging apparatus, a second recording device which records the image data received by said second communications device, and a third communications device which automatically transmits the image data recorded by said second recording device and predetermined user information to a predetermined print server apparatus; and
the predetermined print server apparatus, including: a fourth communications device which receives image data and the predetermined user information from the home server apparatus, a third recording device which records the image data received by said fourth communications device for each user specified by the predetermined user information; a user data management device which manages image data of a user recorded by said third recording device, and a first output device which outputs the image data recorded by said third recording device to a medium when the user issues an order, wherein:
said user data management device updates at least one of a total number of pieces of image data and a total amount of image data about a user specified by the predetermined user information each time said fourth communications device receives image data and the predetermined user information from the home server apparatus, and automatically transmits message information to equipment registered in advance for the user when the updated result exceeds a predetermined value, wherein the message information includes a proposal for the user to output image data to a medium.

2. The print service system according to claim 1, wherein:
communications between said imaging apparatus and said home server apparatus are performed by wireless communications, said imaging apparatus transmits predetermined imaging apparatus information to said home server apparatus, and said home server apparatus receives image data from said imaging apparatus only when the imaging apparatus information received from said imaging apparatus matches imaging apparatus information stored in advance.

3. The print service system according to claim 1, wherein:
said imaging apparatus further comprises a cradle apparatus capable of supplying power to said imaging apparatus, and said imaging apparatus automatically starts wireless communications with said home server apparatus when said imaging apparatus is connected to said cradle apparatus.

4. The print service system according to claim 1, wherein:
image data transmitted by said imaging apparatus is not assigned an identifier, and the identifier is assigned to image data already transmitted to said home server apparatus from said imaging apparatus.

5. The print service system according to claim 1, wherein:
communications between said imaging apparatus and said home server apparatus are performed by wireless communications, said imaging apparatus transmits predetermined imaging apparatus information to said home server apparatus, and said home server apparatus receives image data from said imaging apparatus only when the imaging apparatus information received from said imaging apparatus matches imaging apparatus information stored in advance; and
said imaging apparatus further comprises a cradle apparatus capable of supplying power to said imaging apparatus, and said imaging apparatus automatically starts wireless communications with said home server apparatus when said imaging apparatus is connected to said cradle apparatus.

6. The print service system according to claim 1, wherein:
communications between said imaging apparatus and said home server apparatus are performed by wireless communications, said imaging apparatus transmits predetermined imaging apparatus information to said home server apparatus, and said home server apparatus receives image data from said imaging apparatus only when the imaging apparatus information received from said imaging apparatus matches imaging apparatus information stored in advance;
said imaging apparatus further comprises a cradle apparatus capable of supplying power to said imaging apparatus, and said imaging apparatus automatically starts wireless communications with said home server apparatus when said imaging apparatus is connected to said cradle apparatus; and
image data transmitted by said imaging apparatus is not assigned an identifier, and the identifier is assigned to image data already transmitted to said home server apparatus from said imaging apparatus.

7. A print service system, comprising:
an imaging apparatus including: an imaging device which outputs image data of a photo image obtained by capturing an object, a first recording device which records the image data, and a first communications device which transmits the image data recorded in said first recording device to a predetermined home server apparatus; and
the predetermined home server apparatus including: a second communications device which receives image data from said imaging apparatus, a second recording device which records the image data received by said second communications device, a third communications device which automatically transmits the image data recorded by said second recording device and predetermined user information to a predetermined print server apparatus, and an image data management device which manages image data recorded in said second recording device, wherein:
said image data management device updates at least one of a total number of pieces of image data and a total amount of image data each time said third communications device transmits image data to the specified print server apparatus, and automatically transmits message information to equipment registered in advance when the updated result exceeds a predetermined value; wherein said message information includes a proposal to output image data to a medium from said print server apparatus.

8. The print service system according to claim 7, wherein
said second recording device is either a non-volatile storage device which stores image data for a plurality of images or a volatile storage device which temporarily stores image data.

9. The print service system according to claim 7, wherein:
communications between said imaging apparatus and said home server apparatus are performed by wireless communications, said imaging apparatus transmits predetermined imaging apparatus information to said home server apparatus, and said home server apparatus receives image data from said imaging apparatus only when the imaging apparatus information received from said imaging apparatus matches imaging apparatus information stored in advance.

10. The print service system according to claim 7, wherein:
said imaging apparatus further comprises a cradle apparatus capable of supplying power to said imaging apparatus, and said imaging apparatus automatically starts wireless communications with said home server apparatus when said imaging apparatus is connected to said cradle apparatus.

11. The print service system according to claim 7, wherein:
image data transmitted by said imaging apparatus is not assigned an identifier, and the identifier is assigned to image data already transmitted to said home server apparatus from said imaging apparatus.

12. The print service system according to claim 7, wherein:
said second recording device is either a non-volatile storage device which stores image data for a plurality of images or a volatile storage device which temporarily stores image data; and
communications between said imaging apparatus and said home server apparatus are performed by wireless communications, said imaging apparatus transmits predetermined imaging apparatus information to said home server apparatus; and said home server apparatus receives image data from said imaging apparatus only when the imaging apparatus information received from said imaging apparatus matches imaging apparatus information stored in advance.

13. The print service system according to claim 7, wherein:
said second recording device is either a non-volatile storage device which stores image data for a plurality of images or a volatile storage device which temporarily stores image data;
communications between said imaging apparatus and said home server apparatus are performed by wireless communications, said imaging apparatus transmits predetermined imaging apparatus information to said home server apparatus, and said home server apparatus receives image data from said imaging apparatus only when the imaging apparatus information received from said imaging apparatus matches imaging apparatus information stored in advance; and
said imaging apparatus further comprises a cradle apparatus capable of supplying power to said imaging apparatus, and said imaging apparatus automatically starts wireless communications with said home server apparatus when said imaging apparatus is connected to said cradle apparatus.

14. The print service system according to claim 7, wherein:
said second recording device is either a non-volatile storage device which stores image data for a plurality of images or a volatile storage device which temporarily stores image data;
communications between said imaging apparatus and said home server apparatus are performed by wireless communications, said imaging apparatus transmits predetermined imaging apparatus information to said home server apparatus, and said home server apparatus receives image data from said imaging apparatus only when the imaging apparatus information received from said imaging apparatus matches imaging apparatus information stored in advance;
said imaging apparatus further comprises a cradle apparatus capable of supplying power to said imaging apparatus, and said imaging apparatus automatically starts wireless communications with said home server apparatus when said imaging apparatus is connected to said cradle apparatus; and
image data transmitted by said imaging apparatus is not assigned an identifier, and the identifier is assigned to image data already transmitted to said home server apparatus from said imaging apparatus.
